(19) United States
(12) Patent Application Publication
(10) Pub. No.: US 2011/0290683 A1
(43) Pub. Date: Dec. 1, 2011

(54) GOLF BAG BANNER

(76) Inventors: Randal High, Bloomington, MN (US); Joel Buckley, Plymouth, MN (US)

(21) Appl. No.: 13/117,024

(22) Filed: May 26, 2011

Related U.S. Application Data
(60) Provisional application No. 61/348,658, filed on May 26, 2010.

(51) Int. Cl. A63B 55/06; G09F 17/00

(52) U.S. Cl. 206/315.7; 116/173

(57) ABSTRACT

A golf bag banner includes a flexible body movable between at least a first position and a second position and a connector mechanism to secure the flexible body to a movable leg of a golf bag. A fixture is provided to hold the banner along the length of leg. A golf bag is essentially a container to receive golf clubs therein. A stand mechanism can be connected to the container to provide a bag stand position and a retracted position. The bag banner can be fixed to the stand mechanism, e.g., connected between two legs of the stand mechanism. The bag banner can include a flexible body, e.g., a fabric, movable between at least the stand position and the retracted position and a connector system to secure the flexible body to the two legs. The bag banner can incorporate logos and other insignia that a manufacturer or golfer would like to display with his/her golf bag.

The present application claim the benefit of U.S. provisional patent application No. 61/348,658, titled GOLF BAG BANNER, filed 26 May 2010, which is incorporated by reference herein for any purpose.

### BACKGROUND

The sport of golf is a major professional and recreational activity. Millions of people play the sport on a regular basis in the United States alone. Individual players often desire to distinguish themselves from other golfers by their attire as well as by their quality of play. Many golfers enjoy displaying brands and various insignia on specialized golf clothing and equipment, including hats, shirts, and club covers, however other avenues of display are desired by golfers and advertisers.

A golf bag pouch structure is described in U.S. Patent Application Publication No. 2004/023017, published 25 Nov. 2004 and in its abstract states a golf bag pouch structure located in the planes between the legs of a standing golf bag, and located in between the planes of the legs of a golf bag and the sides of a golf bag.

### SUMMARY

A golf bag banner can include a flexible body movable between at least a first position and a second position and a connector mechanism to secure the flexible body to a movable leg of a golf bag. A fixture is to keep the flexible body in a vertically fixed position along the leg of a golf bag. As a result, the golf bag banner is less likely to interfere with operation of the stand mechanism of a golf bag. The bag banner can extend between the legs of a golf bag and/or between a leg and the golf bag itself.

A golf bag can include a container to receive golf clubs therein; a stand connected to the container, the stand including at least two legs moveable between a stand position and a retracted position; a bag banner connected between the two legs, the bag banner including a flexible body movable between at least the stand position and the retracted position; and a connector mechanism to secure the flexible body to at least one of the two legs. A fixture structure is provided to keep the flexible body in a vertically fixed position along the leg of a golf bag. As a result, the golf bag banner is less likely to interfere with operation of the stand mechanism of a golf bag.

The golf bag banner can provide additional accessories for use while playing or practicing the sport of golf. The banner and any additional accessory allow the stand mechanism to operate in its usual manner.

### BRIEF DESCRIPTION OF THE DRAWINGS

FIG. 1 illustrates a golf bag and an embodiment of a bag banner connected between two legs of the golf bag stand.

FIG. 2 illustrates a front view of the golf bag and bag banner illustrated in FIG. 1.

FIG. 3 illustrates a golf bag with the legs of its stand in a retracted position and an embodiment of a bag banner in a folded or compacted configuration.

FIG. 4 illustrates a golf bag with the legs of its stand in a retracted position and an embodiment of a bag banner in a folded or compacted configuration, where the bag banner does not interfere with the golf bag stand mechanism.

FIG. 5 illustrates a golf bag and an embodiment of a bag banner, wherein the bag banner includes a utility cord for connecting to or attaching to an attachable item.

FIG. 6 illustrates a golf bag and an embodiment of a bag banner, wherein the bag banner includes a utility cord for connecting to or attaching to an attachable item.

FIG. 7 illustrates a golf bag and an embodiment of a bag banner, wherein the bag banner shows an insignia.

FIG. 8 illustrates a slotted strap that can be used as a connector mechanism to connect the bag banner to a leg of a golf bag stand.

FIG. 9 illustrates the reverse side of the slotted strap of FIG. 8, showing a securing protrusion that can secure the strap in a closed position.

FIG. 10 illustrates the slotted strap of FIG. 8 secured around a leg of a golf bag stand and one of the securing posts that has passed through the slot of the slotted strap.

FIG. 11 illustrates a slotted strap with a rod that can be used as a connector mechanism to connect the bag banner to a leg of a golf bag stand.

FIG. 12 illustrates the slotted strap of FIG. 11 secured around a leg of a golf bag stand and shows the rod of the slotted strap that has passed through the slot of the slotted strap.

FIGS. 13A and 13B illustrate a clamp that can be used as a connector mechanism to attach the bag banner to a leg of a golf bag stand.

FIG. 14 illustrates the clamp of FIG. 13 in a closed position around a leg of a golf bag stand.

FIG. 15 illustrates a closure device that can be used as a connector mechanism to attach the bag banner to a leg of a golf bag stand.

FIG. 16 illustrates a cable tie that can be used as a connector mechanism to attach the bag banner to a leg of a golf bag stand.

FIG. 17 illustrates a cable tie that can be used as a connector mechanism to attach the bag banner to a leg of a golf bag stand, where the cable tie has a non-slip backing.

FIG. 18A shows an example of a golf bag with a banner affixed thereto, according to an example embodiment.

FIG. 18B shows an elevational view of the banner, according to an example embodiment.

FIG. 19A shows a side view of an example of a golf bag with a banner affixed thereto, according to an example embodiment.

FIG. 19B shows an elevational view of the banner, according to an example embodiment.

FIG. 19C shows the banner free from the golf bag, according to an example embodiment.

FIG. 20 shows a clamp for fixing a banner to a leg of a golf bag, according to an example embodiment.

FIG. 21 shows a golf bag and one embodiment of a bag banner, according to an example embodiment.

FIG. 22 shows a top view of a c-shaped clamp used as part of a connection system in one example embodiment of a bag banner.

FIG. 23 shows a bridge through which a clamp or connector can extend and then connect to the leg, according to an example embodiment.

FIG. 24 shows a perspective view of banner attached to the legs of a stand mechanism, according to an example embodiment.

FIG. 25 shows a top view of a clamp used as part of a connection system, according to an example embodiment.

FIG. 26 shows a top view of a connector, according to another example embodiment

FIG. 27 shows a cross sectional view of a banner attached to a leg, according to another example embodiment.

FIG. 28 shows a side view of a leg having a slot therein, according to another example embodiment.

FIG. 29 shows an embodiment of the banner in which a pocket is provided which is removable, according to an example embodiment.

FIGS. 30A, 30B, 30C, 30D, 30 E and 30F, show various partial views of banners positioned between a first leg and a second leg of a golf bag, according to example embodiments.

FIGS. 31A, 31B, 31C, 31D, 31E and 31F, show various partial views of banners positioned between one leg of a golf bag stand, and a golf bag, according to example embodiments.

FIG. 32 shows an embodiment of a banner in which a solar panel is provided, according to an example embodiment.

FIG. 33 shows an embodiment of a bag side banner in which a solar panel is provided, according to an example embodiment.

FIG. 34 shows an embodiment of a mechanical stand having only one leg and a banner, according to an example embodiment.

FIG. 35 shows a system for connecting a side banner to a golf bag, according to an example embodiment.

FIG. 36 shows an embodiment of a shawl for covering a golf bag, according to an example embodiment.

FIG. 37 shows a top view of a three sided display device, according to an example embodiment.

FIG. 38 shows a top view of another three sided display device, according to an example embodiment.

FIG. 39 shows a side view of three-sided banner attached to the legs of a stand mechanism, according to an example embodiment.

FIG. 40 shows a perspective view of three-sided banner attached to the legs of a stand mechanism, according to an example embodiment.

FIGS. 41A-41C show views of an output device to be attached to legs of a stand mechanism for a golf bag, according to an example embodiment.

FIGS. 42A-42B show views of a banner connector according to an example embodiment.

All Figures are illustrated for ease of explanation of the basic description and teachings of this disclosure. The extensions of the Figures with respect to number, position, relationship and dimensions of the parts to form the embodiment are further explained herein or are understood by one of skill in the art after the following description has been read and understood. The exact dimensions and dimensional proportions to confirm to specific force, weight, strength, flow, use and similar requirements will likewise be within the skill of the art after the following description has been read and understood.

Where used in various Figures of the drawings, the same numerals designate the same or similar parts. Furthermore, when the terms “top”, “bottom”, “right”, “left”, “forward”, “rear”, “first”, second”, “inside”, “outside” and similar terms are used, the terms should be understood in reference to the drawings and used only to facilitate describing the illustrated embodiments. Typically, these terms are ascribed and should be understood to reference the structures shown in the drawings as they will typically be used.

### DETAILED DESCRIPTION

The present inventors have recognized the heretofore unmet need in the golf community for a convenient device to provide additional functionality to a golf bag and to display an advertisement, association, insignia, identification, logo, picture, message or the like, while playing the game of golf. Moreover, the present inventors have refined a banner attached to the legs of a stand mechanism of a golf bag to reduce the likelihood that the banner would interfere with the operation of the stand mechanism.

Many modern golf bags include a mechanism that allows the bag to stand upright by itself when positioned on a suitable surface, which need not be a horizontal surface. A golf bag is generally a container for golf clubs and other accessories. The golf bag can include legs, poles, or posts that extend from the container. Some golf bags have a stand mechanism that has moveable legs. The moveable legs are designed to have at least two positions: a stand (or extended) position and a retracted position. The legs are in the retracted position when transporting the bag. The legs are in the stand position when the golfer has set the bottom of the golf bag 10 onto the ground. The bottom of the golf bag 10 can include a mechanical lever which deploys the legs 12 to the stand position in response to the weight of the bag 10 being placed on the lever. With the legs 12 in the stand or standing position, the bag remains in a generally upright position. The upright position can have the bag opening through which shafts of golf clubs extend above the ground. Legs 12 can also be in an intermediate position between retracted and fully extended positions. Bag stands began to have widespread acceptance in the mid-1980s even with development beginning in the 1970s.

The present inventors have identified the region between the legs of the stand, and between the legs and the bag, as an undeveloped and unidentified area for innovation. Golfing caters to those who like certain branded products. Logoed shirts, hats, and equipment are the norm in the sport. Golfers like to show that they have the best and latest equipment and, since they are generally competitive and well healed, buy the latest and greatest gear and golfing equipment to either gain a few strokes here and there or to increase enjoyment on the golf course. Advertisers and manufacturers are constantly seeking new ways of displaying their brands. The space between the legs of a golf stand makes a perfect display space for advertisers. In addition to this, golf is generally an individual game. However, there are team competitions for high schools, colleges, and even professionals (the Ryder Cup, for example). At present, there is little chance for tastefully displaying a team affiliation. The space between the legs of the golf stand can also allow teams to display their affiliation. The invention described herein includes various banners or displays that can be attached between the legs of a bag stand and/or between at least one of the legs and the actual golf bag. The displays can be provided with various features and accessorized, as discussed below. Various embodiments will be detailed in the following paragraphs.

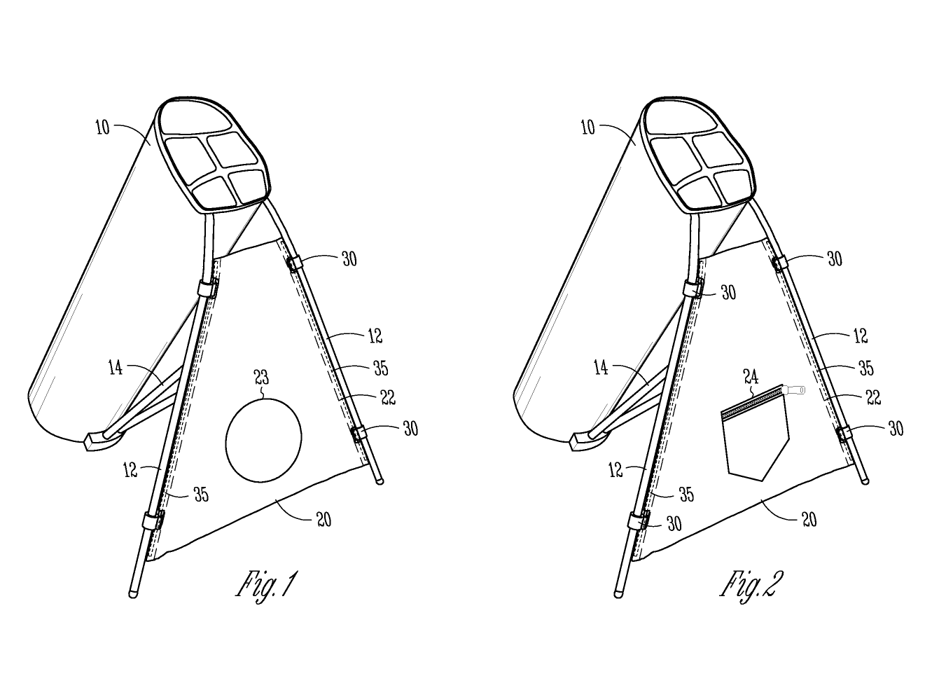

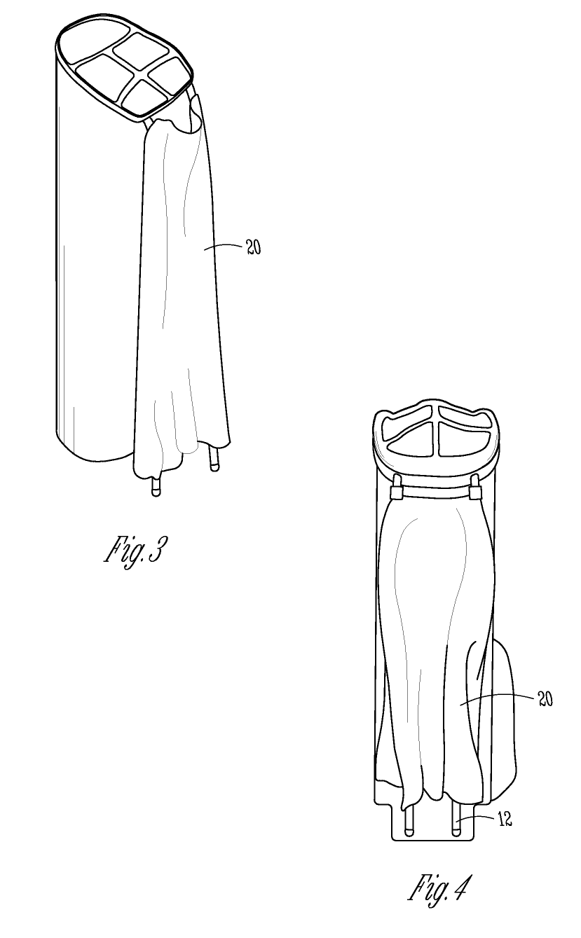

FIGS. 1-4 show a golf bag 10 with a bag banner 20 that can be attached to a post, such as the post or posts or legs 12 associated with a stand mechanism 14 of a golf bag 10. The golf bag defines a container in which golf clubs are stored. FIGS. 1-2 show the bag in a standing position with the legs 12 extended. FIGS. 3-4 show the legs 12 of the golf bag in a retracted position. As shown, the stand mechanism 14 includes at least two legs 12 and an actuator device to move the legs 12 from the retracted position to the standing position. The standing position keeps the clubs within the bag and allows the user access to the clubs without stooping to ground level or holding the bag with one hand while attempting to remove clubs from bag with the other hand. The standing position keeps the bag somewhat above the ground so the golfer need not stoop down to pick up the bag lying flat on the ground between shots. In an example, the standing position positions the golf bag at an angle of about 45 degrees or greater relative to the surface, such as the ground, on which the bag is standing. The legs 12 and a portion of the bottom of the golf bag 10 form a tripod. The golf bag, as a result, remains upright on its own. There is no need for the golfer to spend any time finding perfectly level ground that will match the bottom, closed end of the bag. The golfer need not compensate for the center of gravity not being on the centerline of the golf bag or the golf bag being, at times, top heavy due to the heads of the clubs extending above the open top of the golf bag (not shown). The legs 12 are generally cantilevered from and generally pivot from a pivot point positioned near the top, open end of the golf bag 10. The stand mechanism 25, in some embodiments, controls the pivoting of the legs 12 to keep legs 12 retracted but for the bag moving into a self-standing position. Examples of various golf bag stand mechanisms can be found in U.S. Pat. Nos. 4,834,235; 4,949,844; 5,147,089; 5,156,366; 5,156,366; 5,340,063; 6,062,383; all of which are hereby incorporated by reference for any purpose. However, if any disclosure in the documents that are incorporated by reference conflict with the present disclosure, the present disclosure controls interpretation. In various stand mechanisms, there are actuator rods that extend upwardly from a moveably foot at the bottom of the golf bag upwardly to the legs. The actuator rods force the legs between the retracted and extended positions. The mechanisms and connectors between components are typically open to the environment around the golf bag and may come into contact with items around the golf bag.

In one example embodiment, the bag banner 20 extends between the two legs 12 of the golf bag 10. The bag banner 20 fills the area defined by the stand mechanism 25, e.g., the area between the two legs 12 and/or the area between a leg and the golf bag. In an example, the bag banner 20 extends outwardly from the container portion of the bag. The bag banner 20 can include a flexible body 22. The bag banner 20 also includes at least one connector 30 to fix the banner to the stand mechanism. In an example, a plurality of the connectors 30 connect the edges of the banner 20 to the legs 12 of the golf bag stand 14. The connector 30 can be any type of clip, fastener, hook and loop, buttons, or other mechanical connector or other device for connecting the bag banner 20 to the legs 12 of the golf bag stand 14. The connector can be a single mechanism or clip or a plurality of mechanisms or clips or the like. In an example embodiment, the connector 30 adheres or fixes the banner 20 to the legs 12 of the stand 25. The connector 30 can be any mechanism that connects the banner to the stand. The connector 30 secures a flexible body 22 of the banner to a movable leg 12 of the golf bag 10. The banner 20 can include additional tabs that extend from the flexible body to which the connector 30 can be fixed. Such tabs can extend laterally from flexible body. The tabs can be elastic in an example. In an example, the connector mechanism 30 secures the banner 20 at two or more locations to the legs 12. In an example, the connector mechanism 30 connects the banner at four or more locations to the legs 12. In a further example, the connector 30 secures the corners of the bag banner 20 to the legs 12.

As the legs 12 extend outwardly from the bag and at the free ends extend outwardly from each other in the stand position, the bag banner 20 has a generally trapezoid shape. It will be recognized that the sides of the trapezoid shape may not be perfectly straight, e.g., due to the nature of the banner 20 or installation of the bag banner 20 on the legs 12 of the golf bag. Other shapes for the bag banner 20 are within the scope of the present disclosure, e.g. other parallelograms, triangles, ovals, circles, etc. It should be noted that the shape of the bag banner 20 is adaptable to different designs of the golf bag stand mechanisms 14. For example, a rectangular version of the bag banner 20 could be used if the golf bag stand mechanism 14 includes legs 12 that deploy to a standing position with the legs 12 are substantially parallel. The banner 20 can also be a narrow strip extending between the legs. In some embodiments, the banner 20 can be conveniently attached to and removed from the stand mechanism 14 of golf bags by the connector 30. Attachment can be done by hand by the user. In other embodiments, the banner can be permanently fixed to the stand portion of a golf bag by such connecting mechanisms. Permanent fixture by the connector 30 can be done at the manufacture of the golf bag. In an example, the connector 30 can connect the banner to at least a part or portion of the golf bag. Other connectors can secure the banner 20 to the golf bag.

A fixture 35 is connected to at least one of the bag banner and/or the connector 30. In the example shown in FIG. 1, the fixture 35 includes a stiffening member along each side of the banner. The stiffening member can be a rod or a dowel that is connected along the respective edge of the banner. The stiffening members can be a material that is stiffer than the flexible fabric from which the banner is made. The stiffening members can be multi-layered hem along the edge, where the material of the banner is folded over multiple times or includes layers of materials sewn or adhered together. In the example, shown in FIG. 2, the fixture is a stop adjacent or integrated into the connectors 30. In a specific example, the stop is a protrusion on the leg that prevents the bottom connectors from riding up the leg. A stop is provided below the top connectors 30 to prevent the top connectors from sliding downward on the legs. The fixtures can be integrated into the connectors 30. In an example, the fixture is non-slide surface coating or layer on the connectors to contact the leg and prevent the connectors 30 from sliding on the legs. A non-slide surface can include an adhesive on a side of the connector that contacts the leg of the golf bag. The fixture 35 operates to hold the banner in place on the legs of the golf bag and prevent the banner from riding up and down on the legs. Movement of the banner vertically along the legs can result in the banner 20 bunching together and possibly entangling in the stand mechanism.

For ease of illustration the fixtures 35 are not shown in FIGS. 3-7. Nonetheless, the fixtures 35 can be used in any of the examples shown in FIGS. 3-7 or other embodiments/examples. In these examples, the fixtures can operate to keep the banner elongate along the legs, while the banner holds freely laterally with the golf bag legs.

The golf bag banner 20 includes a flexible body 22 movable between at least a first position (e.g., embodiments of FIGS. 1, 2, and 5-7), and a second position (e.g., embodiments of FIGS. 3 and 4). The flexible body 22 can include a lightweight fabric that can fold with the movable golf bag leg(s) 12, between a retracted position and a bag standing position such that the banner 20 does not interfere with the operation of the stand mechanism 14. That is, the stand mechanism 14 can move from a retracted position to a bag support position with the banner 20 attached to the stand mechanism 14. In an example, the banner 20 does not interfere with at least one of the stand legs 12. The flexible body 22 can be a woven fabric. In an example, the material can be a rip-stop material. The rip stop material can be a light-weight nylon fabric with inter-woven rip-stop reinforcement threads in a crosshatch pattern. Such material can be many different colors, sizes, and thickness. The material is woven with a coarse, strong warp and filling yarns spaced at intervals so that tearing will not spread. In an example, the fabric is a water repellant fabric. In an example, the fabric is a water absorbing fabric, e.g., terry cloth, which a golfer can use to dry hands or clean/dry equipment. The flexible body 22 can include a main body and an elastic edge extending longitudinally with the leg. The elastic edge(s) allow the banner 20 to stretch to match the dimensions of the legs 12, when the legs are extended to the stand position to support the golf bag. In an example, connecting tabs extended laterally from the elastic edge. The connectors 30 can be fixed to the connecting tabs. In some examples, the banner 20 is movable into all of the positions of the legs 12 between full retraction (positioned essentially against the bag) and full extension (outwardly from the bag to the greatest amount as permitted by either the stand mechanism 14 or by the bag banner). In some instances, the legs 12 need not be fully extended to support the golf bag in an upright position.

The banner 20 can further include multiple layers of fabric. The outer layer of fabric can be water repellant (a synthetic material, e.g., nylon) and the inner layer(s) can be water absorbent, for example, terry cloth or other towel like fabric. In an example, the outer layer can be a made of flashspun high-density polyethylene fibers or other a nonwoven synthetic material. Such outer layer is very strong but is resistant to tearing. These materials are highly breathable but resistant to water vapor or liquid water. In an example, the outer, water repellant layer is removably affixed to another underlayer. The flexible body 22 can be a multiple layered construction, for example, with the water repellant layer on the outside and a water absorbing fabric beneath the water repellant layer. As a result, the outer layer will keep the underlayer dry when golfing in the rain. The underlayer can be used by the golfer to dry hands or golf equipment. Moreover, the underlayer is easily accessible as it is not stored in a closed pocket within the golf bag. In an example, the layers can be formed to define a pocket 24 (shown in FIG. 2). The pocket 24 can be small such that it snugly holds a sleeve of golf balls, three or more gold balls, a portable video player or a portable music player. The pocket can be medium sized such that the pocket is positioned intermediate the top and bottom layer. The pocket 24 can be a large sized pocket that essentially extends the entire size of the banner. The pocket 24 can be fur lined or lined with a soft cloth material, e.g., terry cloth or cotton, which can reduce noise of contents in the pocket while carrying the golf bag. Moreover, the folding action of the banner 20 can further operate to secure contents of the pocket from making noise while allowing ease of access to the contents when the golf bag is in the stand position.

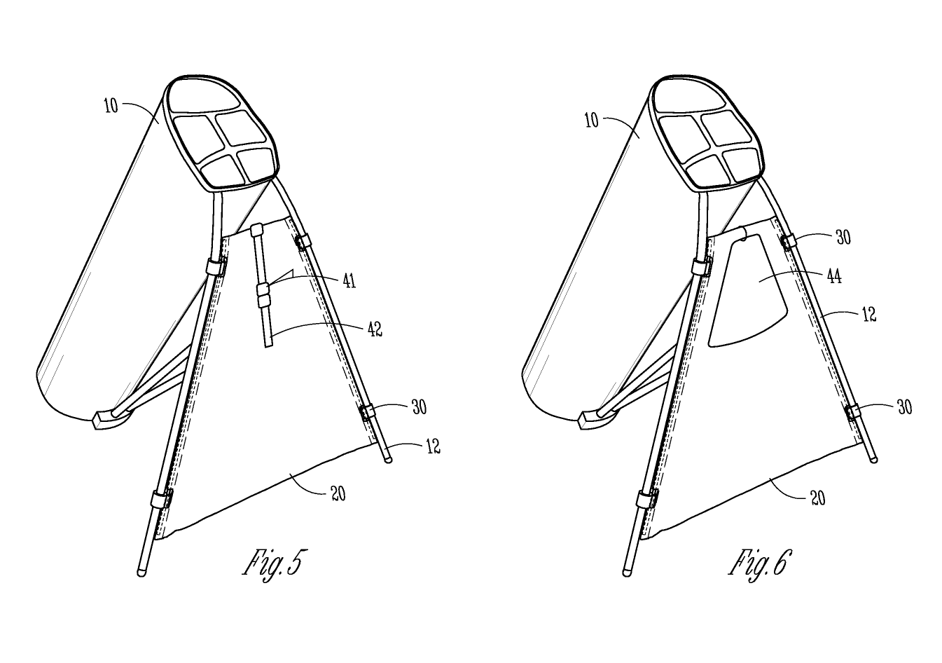

The banner 20 can include various adaptations and accessories 23 (FIG. 1). Examples of adaptations and accessories 23 can include pockets 24 (FIG. 2), connecting cords 41 (FIG. 2), a bag 44 (FIG. 6) and/or utility devices. FIG. 6 illustrates a golf bag having an example embodiment of a bag banner 20, wherein the bag banner includes a utility cord for connecting objects and an oversized pocket or a second bag 44 attached thereto.

Any and all devices that can be used on the golf course or would like to have on the golf course can be affixed to the banner 20. In some embodiments, the bag banner 20 can include one or more magnets fixed to the flexible body 22. In some embodiments, the flexible body can include one or more pockets 24. In some embodiments, the accessories 23 can include one or more speakers, which can reproduce sound from radios, portable music devices, etc., supported by the flexible body 22. In one embodiment, pockets 24 can also be formed and sized so as receive speakers. The pocket 24 can include an outer mesh material or screen type material over the speakers so that the material of the banner does not muffle the output of the speakers. In some embodiments, the flexible body 22 can include one or more flexible elongate connectors, e.g., a connecting cord 41 to which an accessory can be attached. Other devices and accessories can include lights, light emitting diodes, solar cells, and other electronic devices.

A pocket 24 with a transparent outer cover can be in the banner 20. The pocket 24 can store a photograph, which can be positioned in the pocket on the banner such that the photo is visible outside the banner. Such a pocket 24 can also hold a license or other identification.

The second bag 44 can be a dry bag that has a water repellant or water impermeable exterior layer and an water absorbent interior layer that can be used to dry golf club grips or golfer's hands. The interior layer can further include a tacky layer to improve a grip on the club. In a further example, the bag 44 can house a golf bag cover that can extend from the second bag 44 to cover the top of the golf bag 10 and the club heads extending from the golf bag 10. This useful in inclement weather or when storing the clubs.

In operation, when the golf bag is in an upright position, the moveable legs 12 are typically in a retracted position so that the golf bag 10 can be conveniently carried its user. In this position, the banner 20 can be in a folded or compacted arrangement (retracted position) so that it does not hinder the transport of the golf bag. The banner 20, being flexible, allows the banner to freely move between its compact arrangement and its extended, display arrangement (stand position). When the golf bag 10 is in a “landed” or standing position, the moveable legs 12 of the golf bag 10 are typically extended from the golf bag 10 so as to form a tripod configuration. The legs 12 are cantilevered from above the mid-length of the bag 10 so that the lower free ends of the legs 12 contact the ground in the tripod configuration. The free ends of the legs 12, in an example, also move outwardly from each other when deployed in the tripod configuration. The banner 20, which can be secured to two moveable legs 12 of the golf bag 10, can be unfolded or uncompacted so that it is in a display position as and when the legs 12 are deployed. The display position can be substantially flat arrangement or a stretched arrangement in the landed position of the bag 10. The fixtures 35 operate to keep the banner in an elongate orientation along a leg of the golf bag, in both the unfolded position and the folded position of the legs, which reduces the likelihood that the banner will interfere with operation of the stand mechanism.

FIG. 7 illustrates a golf bag 10 and a bag banner 20, wherein the bag banner 20 shows an insignia, according to an example embodiment. Deploying the legs deploys the banner 20 to allow the banner 20 to be displayed such that any image on the banner 20 can be viewed, see e.g., FIG. 7. Images that can be viewed include insignias, logos, school names, company names, advertisements, and the like. In an example, a player name and/or number as well as a team name for a player on a golf team. The landed or deployed position also allows for convenient access to any accessories (e.g., pockets 24 on the banner, tools or devices) that can be optionally connected to the banner 20.

Thus, the flexible body 22 of the golf bag banner 20 is movable between at least a first position and a second position. In a first position, the bag banner 20 can be in a folded or compacted arrangement, such as when the golf bag 10 is to be carried or stowed. The compacted arrangement includes the flexible body 22 overlapping itself so that it can allow the legs 12 to retract into their non-stand or retracted position. This could also be termed as a folded or undeployed position. The flexible body 22 can further extend behind the legs 12, intermediate the legs 12 and the bag 10 and not interfere with the operation of the stand mechanism 14. In a second position, the bag banner can be unfolded or uncompacted, thereby presenting the flexible body of the bag banner in a substantially flat configuration when the bag is in a landed or standing position.

The flexible body 22 of the bag banner 20 can be made of any material that suitably compacts or folds when the moveable legs 12 of a golf bag 10 are retracted, for example, from a tripod-like standing position of the golf bag 10. The material can be, for example, a woven material. The material can be a non-woven polymer. The material can be elastic. The material can be lightweight, e.g. less than a pound. The material can have non-fade properties as the banner 20 will be in the sun on a golf course. The material can be water-resistant, and/or the banner can include a water-repellant outer layer. The material can be netting material, optionally with printing on the netting, or with a separate portion of material attached to the netting, where the separate portion of material can include an image, for example, words or a design (shown in FIG. 7). The material can be a multiple layer construction. The material can be a synthetic, natural, polymer, nylon, or combinations thereof.

In some embodiments, the flexible body 22 of the bag banner 20 can include a main body and an edging. The edging can serve as a physical reinforcement of the material to increase durability. The edging can be elastic. The elastic can be a border, for example, being included on each edge of the flexible body 22, or the elastic can extend longitudinally with the legs 12 of the golf bag 10, so that the flexible body 22 is tightly stretched when the legs 12 of the golf bag 10 are in an extended position. The elastic can function to guide the flexible body away from the mechanism 14 of the golf bag 10 that extends and retracts the moveable legs 12. The edging can include the fixture to keep the bag banner 20 extended along a leg of the golf bag, e.g., a stiffener to keep the banner extended.

In some embodiments, the golf bag 10 includes a lever that activates a stand mechanism, e.g., a linkage, which extends the legs 12 from a retracted position to an extended position so that the bag 10 can stand in a tripod configuration. When the bag 10 is lifted, or the lever is activated in a reverse manner, the legs 12 of the golf bag 10 collapse and the banner 20 collapses along with the legs 12, resulting in the banner 20 collapsing between the legs 12, in a manner that does not interfere with the retracting mechanism of the legs 12.

Turning again to FIG. 7, it shows the banner with an image 45 thereon. The face of the banner 20 can be of any desired color. The banner 20 can also have a blank face suitable for custom printing as desired by a consumer. The banner 20 can display a variety of messages, insignias, and/or advertisements. For example, company names such as golf product company's names or logos can be imprinted on the banner 20. The displays can include text, an image 41, sponsorship identification, golfer identification, trademarks including team logos, modified athletic jerseys, and the like. In the example shown, the image includes a likeness of a football jersey is shown with a team logo, a player name and a player number. The image 41 can also show NASCAR images and/or trade dress of racing teams and drivers. Any combination of these of other insignia 41 that can be imprinted on a fabric can be used on the banner. In some embodiments, the banner 20 can have a blank face on the flexible body 22. It will be within the scope of the present disclosure to place the insignia or other image using other techniques than printing, e.g., dying, dye-sublimation, weaving, etc.

One or more connector mechanisms 30 secure the banner 20 to the golf bag 10. More specifically, the connector mechanism 30 functions to secure the flexible body 22 to a movable leg 12 of a golf bag 10. In an example, the leg 12 is pivotal from a retracted position against the bag and an extended position away from the bag. The connector mechanism 30 must hold the banner 20 in place on the legs 12 when the legs 12 move between positions. Moreover, the connector mechanism 30 must not interfere with operation of the stand device or stand mechanism 14. The connector mechanism 30 further holds the banner 20 substantially laterally taut when the legs 12 are in the extended position. When the bag banner 20 is connected by one or more connector mechanisms 30 to a golf bag 10 that includes two legs 12 for standing the golf bag 10 in a tripod configuration, the banner 20 will then be open in a substantially flat configuration to display any optional wording or insignia printed or attached to the flexible body 22. The fixtures 35 can be part of the connectors 30 or the legs 12 to hold the banner in its vertically extended position in both the extended position and the retracted position.

The connector mechanism or mechanisms 30 can be any device that securely attaches the bag banner 20 to legs 12 of a golf bag 10, for example, a golf bag that includes a tripod-type stand. In any embodiment described herein, the bag banner 20 can include one more connector mechanisms 30, which can suitably secure attachment to the legs 12 of the golf bag 10. The connectors 30 can be hardware, synthetic materials, natural rubber, or a cloth. In the embodiment, the fixtures 35 are on the connectors, specifically, on the side of the connectors that join or contact with the legs of the golf bag.

In some embodiments, the flexible body 22 can include a hook and loop fastener material along one or more borders of the flexible body. The hook and loop fasteners operate as the connector mechanism 30. In an example, the hook and loop fastener is on the edge portion of the flexible body 22 of the bag banner 20. A hook and loop fastener material is available from Velcro Inc. of the Dutch Antilles under the product name VELCRO™. The hook and loop fastener material can connect to a portion of the flexible body 22 to a second portion of the flexible body 22 so as to secure a leg 12 of the golf bag 10 within a portion of the flexible body 22. In an example, the hook portion of the hook and loop fastener material and the loop portion are on a same portion of the flexible body 22 such that the edge of the flexible body, or a part thereof, is wrapped around a leg to align and contact with the other of hook and loop fastener material. The back side of the hook and loop fastener can include a adhesive to operate as the fixture 35 to vertically fix the hook and loop fastener on the leg of the golf bag. In an example, one part of the hook and loop fastener is on the banner 20. The other part of the hook and loop fastener is positioned on the leg 12.

In some embodiments, the flexible body 22 can include one or more zippers along the border of the flexible body 22. The zippers can connect to a portion of the flexible body 22 or to a portion of the banner itself so as to secure a leg 12 of the golf bag 10 within the zippered portion of the flexible body 22. One part of the zipper can be fixed to the leg of the golf bag and operate as the fixture to hold the banner in place.

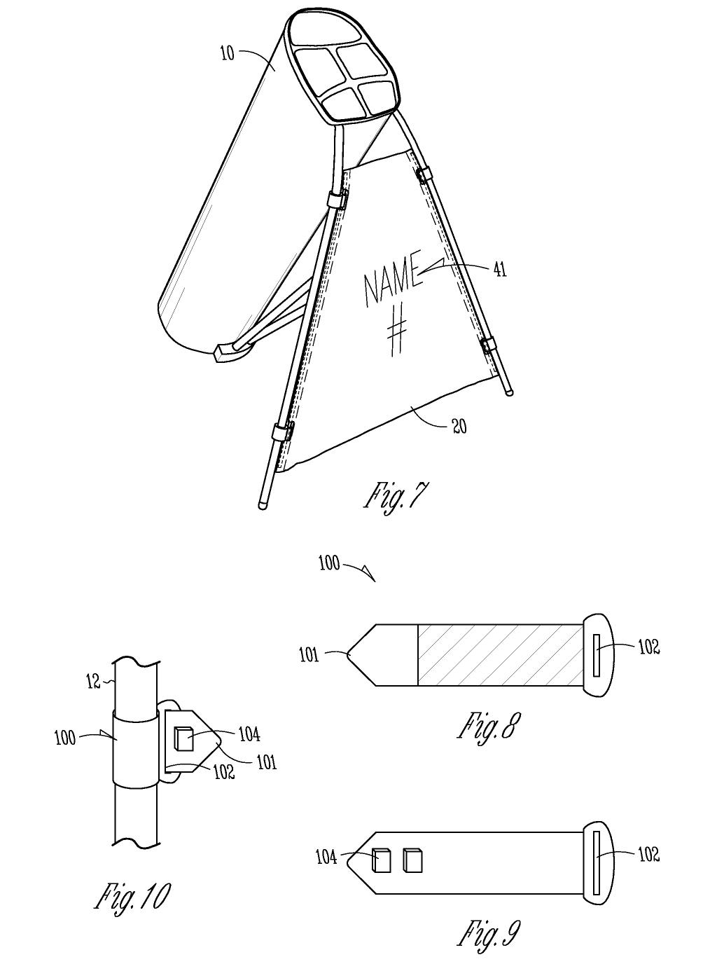

FIG. 8 illustrates a slotted strap 100 that can be used as a connector mechanism 30 to connect the bag banner 20 to a leg 12 of a golf bag stand. FIG. 9 illustrates the reverse side of the slotted strap 100 of FIG. 8, and shows a securing protrusion that can secure the strap in a closed position. FIG. 10 illustrates the slotted strap of FIG. 8 secured around a leg 12 of a golf bag stand and one of the securing posts that has passed through the slot of the slotted strap. FIGS. 8-10 show the connector mechanism 30 as strap 100. The strap 100 can operate as its own fixture, with the fixture being able to be pulled tight enough to provide a friction fit to the leg or enough tension on the leg to prevent the strap 100 from sliding on the leg 12. The strap can be sewn to the flexible body 22 of the banner 20. In a further example, the strap 100 is received through a through aperture in the body 22. In an example, the strap is received through the border edge on the banner 20. In an example, the strap 100 is received through the banner 20 itself. The strap 100 is elongate and includes a first angled or pointed end 101. The first end 101 can also be flat. The second end includes slot 102 that is dimensioned to receive the first end 101. The side of the strap 100, shown in FIG. 8, is adapted to contact the outer surface of a golf bag leg. In an example, the strap 100 includes a rubber material that grips the leg 12 with sufficient force to fix the banner 20 to the leg 12. The strap 100 exerts as much force as needed to secure the banner 20 to the stand mechanism, e.g., a leg 12. In an example, the strap 100 exerts a force of at least two pounds on the leg 12. The strap 100 can be wrapped around a leg 12 of the golf bag stand 14 to secure the banner 20 to the leg 12. In an example, the strap is about two and half inches long +/−0.5 inch. The strap can have a height of about ¾ inch, +/−¼ inch. The strap can have a thickness of 1 millimeter or greater. The slot 102 will be dimensioned to receive the height and width of the strap 100 therethrough. The other side of the strap 100 is shown in FIG. 9. Securing post(s) 104 are positioned adjacent the first strap end. These posts 104 extend outwardly from a surface of the strap. In an example, the posts are five times wider than the first end of the strap. The strap 100 is fixed to the golf bag leg 12 in FIG. 10. The first end 101 extends around the leg 16 and through the slot 102. The first end is pulled through the slot 102 to a length whereat the post 104 is pulled though the slot 102. The post 104 acts as a stop to prevent the strap from releasing the post 12. Specifically, the post cannot pass back through the slot without significant force.

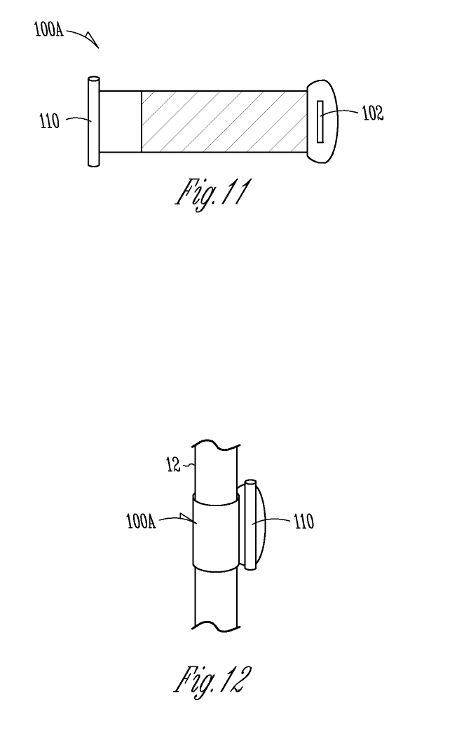

FIG. 11 illustrates a slotted strap 100A with a rod that can be used as a connector mechanism to connect the bag banner 20 to a leg 12 of a golf bag stand. FIG. 12 illustrates the slotted strap of FIG. 11 secured around a leg 12 of a golf bag stand and shows the rod of the slotted strap 100A that has passed through the slot of the slotted strap. FIGS. 11-12 show a further embodiment of a strap 100A. Strap 100A is similar to strap 100 described herein but with a post 110 at the end of the first end 101, which is not pointed as shown in FIG. 8. The post 110 is taller and wider than the remainder of the strap. In an example, the post 110 has a harder durometer rubber then the remainder or rest of the strap. In an example, the post is an injection molded plastic. The post 110 is forced through the slot 102 to fix the strap to the golf bag leg 12, see FIG. 12.

The strap 100A can operate as its own fixture, with the fixture being able to be pulled tight enough to provide a friction fit to the leg or enough tension on the leg to prevent the strap 100 from sliding on the leg 12.

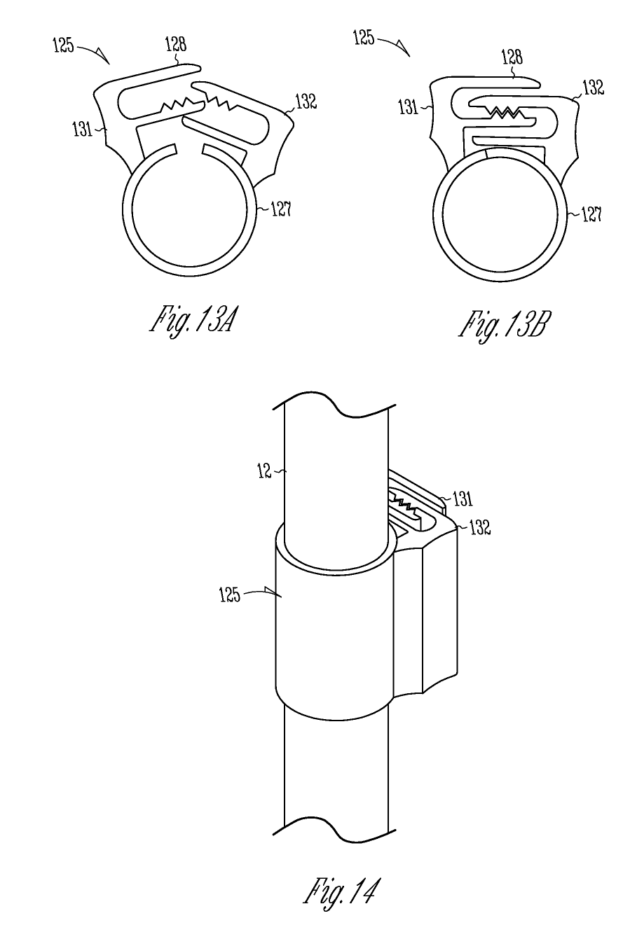

FIGS. 13A and 13B illustrate a clamp 125 that can be used as a connector mechanism 30 to attach the bag banner 20 to a leg 12 of a golf bag stand. FIG. 14 illustrates the clamp 125 in a closed position around a leg 12 of a golf bag stand. FIGS. 13A, 13B and 14 show a clamp 125 that can be used to fix the banner to the golf bag leg. The clamp 125 includes a band 127 defining a circular opening for receiving the golf bag leg and a ratchet closure 128 at free ends of the band 127. The clamp 125 can be formed from a plastic, a nylon, a polymer, or combination thereof. The ratchet closure 128 is shown in the open position in FIG. 13A. The ratchet closure 128 can be further opened to allow the leg to pass into the interior of the band 127. The ratchet closure 128 includes teeth on two separate arms 131, 132. The arms 131, 132 can be pressed together so the teeth lock together while reducing the diameter of the band 127 around the golf leg. The arms 131, 132 are of sufficient width and strength so that they do not move apart once connected. A top extension of the first arm 131 extends above the second arm 132 to cover the second arm 132 to hold the arms and hence the teeth together once engaged.

The clamp 125 can operate as its own fixture, with the fixture being able to be pulled tight enough to provide a friction fit to the leg or enough tension on the leg to prevent the clamp 125 from sliding on the leg 12.

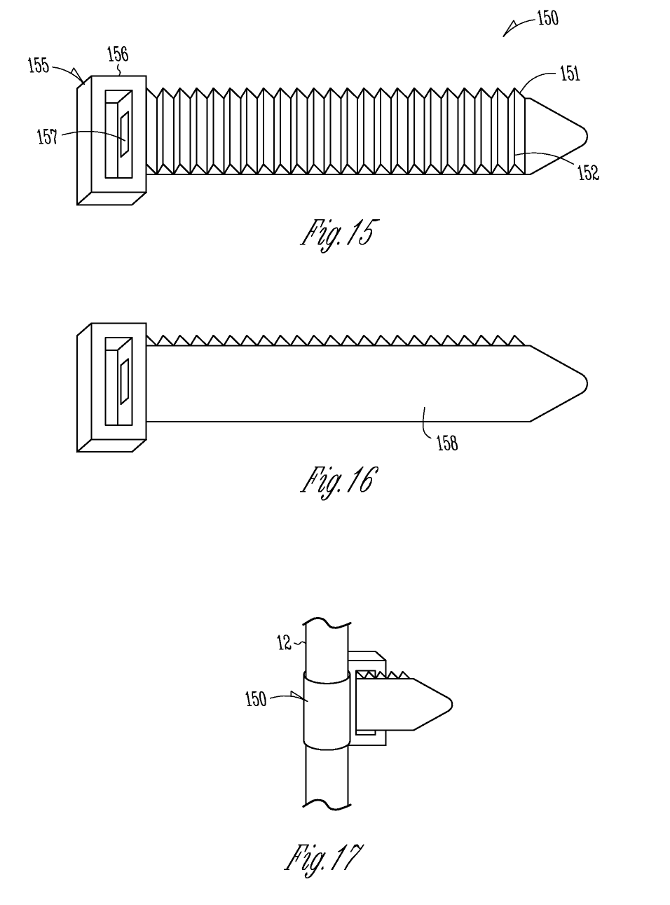

FIG. 15 illustrates a closure device that can be used as a connector mechanism to attach the bag banner 20 to a leg 12 of a golf bag stand. FIGS. 16 and 17 illustrate a cable tie 150 that can be used as a connector mechanism to attach the bag banner 20 to a leg 12 of a golf bag stand. FIGS. 15-17 show a tie 150 that has an elongate body 151 that include teeth 152 on at least one side. One end of body 151 includes a ratchet 155 including a ratchet case 156 and a ratchet 157 in the ratchet case. In an example, the side 158 of the body opposite the teeth is adapted to engage the golf bag leg 12. Side 158 can include a layer that improves the grip of the tie on the leg 12. In an example, the layer 158 is a rubber backing or elastomeric backing which yields as the tie 150 is tightened and then grips the leg 12 to which is attached. In an example, layer 158 can be thermo plastic rubber. Other adhesive materials can be part of layer 158. The tie 150 can operate as its own fixture, with the tie being able to be pulled tight enough to provide a friction fit to the leg or enough tension on the leg to prevent the tie 125 and hence the banner from sliding on the leg 12.

In some embodiments, the connector mechanism 30, e.g., strap 100, strap 100A, clamp 125 or tie 150, engages a button hole, grommet, or slot in the flexible body 22 to fix the banner to the golf bag leg(s) 12. Other embodiments of the connector mechanism 30 can include a cord, strap, lace, or other tying instrument that can be used to secure the banner 20 to the leg 12 of the golf bag 10. These connector mechanisms 30 can be a natural, manmade, or hybrid material. The connector mechanism 30 wraps around the leg 12 and extends through the button hole, grommet, or slot. The slot can be formed by an elongate bridge fixed at the ends thereof with the intermediate portion being free to create a through hole on the banner. The cord, strap, lace, or other tying instrument can be any length of material suitable for tying around the moveable leg 12 of the golf bag 10 and through the button hole, grommet, or slot.

In some embodiments, the connector mechanism 30 can be a tube formed from the outside edges of the flexible body 22. When the flexible body is formed from a sewable material, the tube is formed by hemming the edge of the material and sewing the edge at a distance offset from the folded edge. In some embodiments, the connector mechanism 30 can be a tube that is attached to the flexible body 22 that is suitable to receive a moveable leg 12 of the golf bag 10. The fixture can be a friction fit along part of the length of the tube to hold the banner in place along the leg. The fixture can also include a closed tube whereat the closed bottom operates to keep the tube from riding up the leg of the golf bag. In some embodiments, the connector mechanism 30 includes parachute clips and straps that can be used to secure the bag banner 20 to the legs 12 of a golf bag stand 14. The clips can be releasable but have sufficient closing strength to hold the banner to the leg. In an example, such a clip is similar to a strong hair clip type device. The clips and/or straps can include a fixture as described herein to fold the respective clip or strap in place on the leg of the stand mechanism of a golf bag. In another example, the clips and/or straps interact with a fixture that is on the leg of the stand mechanism.

The bag banner 20 can be attached to legs 12 of a golf bag stand 14 by a variety of connector mechanisms 30. The bag banner 20 can be attached to a leg 12 substantially along the entire length of one edge of the bag banner 20, or the bag banner 20 can be attached to a moveable leg 12 at two or more separate locations along the length of the moveable leg. In some embodiments, the bag banner 20 can be attached at four total locations, two along each of two opposite sides of the bag banner. In other embodiments, the bag banner 20 can be attached at six total locations, three along each of two opposite sides of the bag banner. In other embodiments, eight, ten, or twelve sites can be used to attach the bag banner 20 to the moveable legs 12.

A variety of mechanisms can be used as a connector mechanism 30. A magnet can be used as a connector mechanism 30. A lanyard can be used as a connector mechanism 30. A retractable lanyard can also be used as a connector mechanism. A synthetic rope, such as nylon, can be used as a connector mechanism 30. String or twine can be used as a connector mechanism 30. A carabineer can be used as a connector mechanism 30. A leather strap can be used as a connector mechanism 30. A plastic or rubber coil can be used as a connector mechanism. A split ring can be used as a connector mechanism. A metal rope or string can be used as a connector mechanism. A grommet and a length of material can be used as a connector mechanism 30. Hook and loop fastener can be used as a connector mechanism. Staples can be used as a connector mechanism 30. Tape can be used as a connector mechanism 30. Bonding agents, such as glue, rubber cement, or other adhesives, can be used as a connector mechanism 30. A zipper can be used as a connector mechanism. A parachute clip can be used as a connector mechanism. Cable ties can be used to as a connector mechanism. Rubber bands or elastic bands can be used as a connector mechanism 30. Straps made of synthetic or natural material can be used as a connector mechanism. An elastic cord can be used as a connector mechanism. Button holes and a length of material can be used as a connector mechanism 30. A loop and button hole mechanism can be used as a connector mechanism 30. A loop and hardware can be used as a connector mechanism. A clamp, such as a plastic or metal clamp, can be used as a connector mechanism 30. A nut and bolt can be used as a connector mechanism. Also, hooks, such as flexible clamping hooks, can be used as a connector mechanism 30. The connector mechanism can be affixed to the stand mechanism 14, e.g., to the leg 12. The manufacturer of the stand mechanism 14 or the golf bag 10 can affix the banner 20 to the golf bag 10 prior to sale. The banner 20 can also be an after market add-on to the golf bag 10.

The connector mechanism 30 can be a slotted strap 42. FIG. 8 illustrates a suitable slotted strap 42. The strap can be rubber. In one embodiment, the slotted strap 42 is about 0.75 to about 2.5 inches wide and about 1-4 mm thick. The strap 42 can include securing posts 46 (FIG. 9) that lock the strap in place when the securing posts 46 are inserted through the slot 44 of the slotted strap 42. The material of the slotted strap 42, for example rubber, can have a surface that does not readily slide up or down the moveable leg 12 of a golf bag stand 14. FIG. 10 illustrates the slotted strap 42 secured around the leg 12 of a golf bag. The strap can loop through a slot or opening in the flexible backing 22 in order to secure the flexible backing 22 to the moveable leg 12.

In another embodiment, the connector mechanism 30 can be a slotted strap 50 with an attached rod. In a similar manner to slotted strap 42, the slotted strap 50 with an attached rod can loop through a slot or opening in the flexible backing 22 in order to secure the flexible backing 22 to the moveable leg 12.

In some embodiments, the connector mechanism 30 can be a harness clamp tie. Suitable harness clamp ties are described in U.S. Patent Publication No. 2007/0023586 (Geiger), which is incorporated herein by reference in its entirety. In some embodiments, the connector mechanism 30 can be a cinch strap. Suitable cinch straps are described in U.S. Pat. No. 7,131,168 (Pangallo), which is incorporated herein by reference in its entirety. In some embodiments, the connector mechanism 30 can be a strip and tying arrangement. Suitable strips and tying arrangements are described in U.S. Pat. No. 7,278,188 (Kurmis), which is incorporated herein by reference in its entirety.

In embodiments where the connector 30 includes a strap or other connector that extends around the leg of the golf bag, the fixture can be an aperture in the leg through which the connector 30 threads through to fix the connector 30 in a vertical position on the golf bag leg.

The bag banner 20 can be of plain construction, e.g., an unadorned flexible body 22 with connector mechanisms 30 for its attachment to the moveable legs 12 of a golf bag 10. Alternatively, the bag banner 20 can include a variety of optional utility devices (e.g., pocket 24). For example, the bag banner 20 (or the flexible body 22 of the bag banner 20) can include a pocket 24, or several pockets 24. The pockets 24 can be any suitable size in order to receive useful or desired objects. A pocket 24 can be of a shape that allows a user to conveniently carry various items, such as a wallet, identification, club brushes, divot repair tools, a rain cover for the bag, head covers, and the like. The pockets 24 can include a liner, such as a soft woven material, velvet, or a fur-like material. A closure is provided that closes an opening in the pocket 24. Examples of closures can include a zipper, hook and loop fastener, buttons, snaps, and other fasteners.

A pocket 24 of the bag banner can be open at the top, without any closure mechanism. The pocket 24 can also include a zipper mechanism at the top of the pocket, or at the side of the pocket. The pocket 24 can be designed to securely hold a magnet. The magnet can be sewn into the banner apart from the pocket 24. In an example, the magnet is positioned above the pocket and below the top edge of the banner. A lanyard may hold the magnet on the outside of the banner. Magnets can be used to attach tools to the banner 20, such as a divot tool, a multi-tool, or any ferrous metal object of suitable size and weight with respect to the strength of the magnet. A pocket 24 can be designed to hold a score card. Another pocket can be designed to receive a pencil or other writing tool. The bag banner 20 or the pocket 24 can also include an attached pencil sharpener.

In some embodiments, one or more magnets can be included in the bag banner 20 and attached to the bag banner 20 by an adhesive or by stitching between two pieces of material that make up the flexible body 22, when the flexible body 22 includes more than one layer of material. The magnets can be used as described above.

In some embodiments, the bag banner 20 can include an elongate accessory connector. The elongate connector can be flexible or the elongate connector can be inflexible. A flexible elongate connector can be, for example, a coil cord that terminates in a loop, ring, parachute clip, retractable clip, lanyard or the like.

In some embodiments, the bag banner 20 can include one or more hook and loop fastener strips. The hook and loop fastener can be used to attach additional pockets or accessories such as a towel. In some embodiments, the bag banner 20 can include one or more grommets to enable attachment of accessories. In some embodiments, the bag banner 20 can include one or more carabineers to enable attachment of accessories.

In some embodiments, the banner 20 can include eye holes or grommets that allow the user to attach tools or other object to the banner 20. The attached objects or items can include towels, practice nets, club cleaning tools, laser distance tools, solar powered fans, cleat cleaners, electronic devices, radios, speakers, solar panels, hand dryers, and the like.

In one embodiment, the banner 20 can be plain (no insignia) with an open pocket. In other embodiments, the banner 20 can include a pocket 24 with a zipper. In some embodiments, the banner 20 can include a pocket 24 with a hook and loop fastener closure. In some embodiments, the banner 20 can include a pocket 24 with a button closure. In some embodiments, the banner 20 can include a pocket 24 with a snap button closure. In some embodiments, the banner 20 can include a pocket 24 with a ziplock closure. In some embodiments, the banner 20 can include a pocket 24 with a tie toggle closure. The pocket can be insulated or made of an insulative material to keep contents therein cool or warm.

A pocket 24 of the bag banner 20 can be lined, or it can be without lining. The lining can be a soft material, such as a fabric that prevents abrasion of its contents (e.g., a cell phone or other digital device). The lining can be any lining material used in the art, such as fur, fake fur, velour, chamois, shammy, lamb skin, or other soft cloth.

The bag banner 20 can also include attachable and/or integrated items. When an item is described as being attachable, it can also optionally be integrated into the bag banner 20, for example, by use of an adhesive or by use of additional material stitched to a layer of the bag banner 20. One attachable item is a divot fixer. Another attachable item is a cleat cleaner. Another attachable item is a club cleaner. Another attachable item is a timer or clock. Another attachable item is a slot or pouch for spectacles or sunglasses. Another attachable item is a pouch for golf tees. The bag banner can also include slots or double button holes configured to receive individual golf tees. Another attachable item is a towel. Another attachable item is a brush, such as a club brush. Another attachable item is a ball holder. Another attachable item is a ball cleaner. Another attachable item is a laser line. Another attachable item is a tape measure or other measuring device. Another attachable item is a distance reader. Another attachable item is a position sensing or position displaying device. An example of such a device is a global positioning device, “GPS” device. Another attachable item is a cell phone holder. Another attachable item is a radio. Another attachable item is a speaker. Another attachable item is a music system, such as an MP3 player or other digital device that plays music. Another attachable item is a video system. Another attachable item is a scorecard. Another attachable item is a pencil. Another attachable item is a pen or marker. Another attachable item is a pencil sharpener. Another attachable item is a beverage or drink holder. Another attachable item is a score counter. Another attachable item is a cleat cleaning tool. Another attachable item is a head cover. Another attachable item is a golf glove. Another attachable item is a hat. Another attachable item is a visor. Another attachable item is a fan, for example, a solar fan. Another attachable item is a poster. Another attachable item is a licensed photo. Another attachable item is hand sanitizer. Another attachable item is a multi tool. Another attachable item is an umbrella. Another attachable item is a chipping practice target or hole. Another attachable item is a ball marker or ball identifier. Another attachable item is a ball ID system. Another attachable item is a club rain shield. Another attachable item is a bag protector handle. Another attachable item is a grip cleaner. Another attachable item is a hitting net. Another attachable item is a glove dryer or system. Another attachable item is a golf instruction tool or device. Another attachable item is a camera. Another attachable item is a digital recording device. Another attachable item is a sun screen or sun block. Another attachable item is a rule book. Another attachable item is a pamphlet or handbook. Another attachable item is printed material. The bag banner can also include a fold-down panel that provides additional features described herein and/or a display.

The attachable and/or integrated items can be attached to the bag banner 20 by a variety of mechanisms. The attachment can be a single attachment, or a plurality of attachment devices, in order to suitable secure the item to the bag banner 20. For example, a magnet can be used to attach an item to the bag banner 20. Additionally, a lanyard can be used to attach an item to the bag banner 20. A retractable lanyard can also be used to attach an item to the bag banner. A synthetic rope, such as nylon, can be used to attach an item to the bag banner 20. String or twine can be used to attach an item to the bag banner 20. A carabineer can be used to attach an item to the bag banner. A piece of leather can be used to attach an item to the bag banner. A plastic or rubber coil can be used to attach an item to the bag banner 20. An expandable coil can be used to attach an item to the bag banner 20. A split ring can be used to attach an item to the bag banner 20. A key chain can be used to attach an item to the bag banner 20. A metal rope or string can be used to attach an item to the bag banner 20. A grommet can be used to attach an item to the bag banner 20. Hook and loop fastener can be used to attach an item to the bag banner 20. Staples can be used to attach an item to the bag banner 20. Tape can be used to attach an item to the bag banner 20. Bonding agents, such as glue, rubber cement, or other adhesives, can be used to attach an item to the bag banner 20. A zipper can be used to attach an item to the bag banner 20. A parachute clip can be used to attach an item to the bag banner 20. Cable ties can be used to attach an item to the bag banner 20. A polymer that can be extruded can be used to attach an item to the bag banner 20. A polymer that can be molded can be used to attach an item to the bag banner 20. A polymer that can be vacuum formed can be used to attach an item to the bag banner 20. A material that can be forged can be used to attach an item to the bag banner 20. A material that can be die-cast can be used to attach an item to the bag banner 20. Rubber bands or elastic bands can be used to attach an item to the bag banner. Ethylene-vinyl acetate (EVA) foam can be used to attach an item to the bag banner 20. Pipe insulating foam can be used to attach an item to the bag banner 20. Silicone over molds can be used to attach an item to the bag banner 20. Straps made of synthetic or natural material can be used to attach an item to the bag banner 20. A bungee cord can be used to attach an item to the bag banner 20. A scoot guard can be used to attach an item to the bag banner 20. Button holes can be used to attach an item to the bag banner 20. A loop and button hole mechanism can be used to attach an item to the bag banner 20. A loop and hardware can be used to attach an item to the bag banner 20. A clamp, such as a plastic or metal clamp, can be used to attach an item to the bag banner 20. Screws can be used to attach an item to the bag banner 20. Nails can be used to attach an item to the bag banner 20. Hooks can be used to attach an item to the bag banner 20.

Items can be sewn to the flexible body 22 of the bag banner 20. Items can also be attached to the banner 20 using hook and loop fastener or a zipper attached to the banner 20 or formed to attach to an extended border of the banner 20.

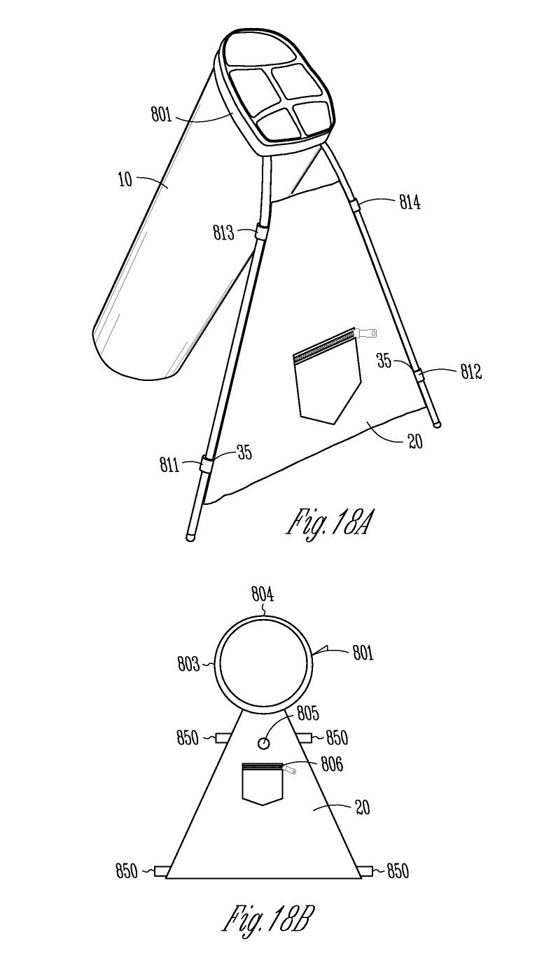

FIG. 18A shows an example of a golf bag 10 with a banner 20 affixed thereto. FIG. 18B shows an elevational view the banner 20. The banner 20 includes a collar 801 that extends outwardly from the top of the banner. In an example, the collar is adjacent the top of the banner 20. The collar 801 extends around the top of the golf bag to fix a top part of the banner 20 to the bag. In an example, the collar includes two cantilevered arms 803, 804, which can at least partially overlap each other when positioned around and attached to the golf bag 10. The arms 803, 804 can each include one part of a hook and loop fastener that can affix to the top part of the golf bag. The first part of the hook and loop fastener is attached to one of the arms 803, 804 and the other part of the hook and loop fastener is attached to the other of the arms 803, 804. Other fasteners can be used on the arms 803, 804 to connect to the golf bag. The collar 801 has a tight fit so that the banner 20 is fixed in place vertically and laterally. Additional connectors 811, 812 are at the bottom of the banner and respectively affix to right and left legs 12 of the golf bag. Additional connectors 813, 814 can be provided at the sides of the banner 20. The connectors 813, 814 are intermediate the collar 801 and the lower connectors 811, 812. Intermediate connectors 813, 814 respectively affix to right and left legs 12 of the golf bag. The connectors 813, 814 can be aligned with the pocket in the banner. In an example, the connectors 813, 814 are aligned with the opening of the pocket (such as a pocket 24 shown in FIG. 2). In an example, the connectors 813, 814 are at the same height at the magnet or accessory attachment on the banner. At least the lower connectors 811, 812, and optionally the intermediate connectors 813, 814, hold and fix the banner 20 in place on the golf bag, e.g., on stand mechanism such that the banner does not slide up or down the bag or stand mechanism 14 during use. The collar 801 can operate as part of a fixture structure that prevents the banner from sliding vertically downwardly. However, additional fixture structures e.g., fixtures 35, are provided to keep the banner 20 from sliding upwardly on the golf bag leg.

FIG. 18A further shows tabs 850 extending from each side of the banner 20. The tabs 850 extend outwardly from the main body of the banner 20. The tabs 850 are elongate and can extend generally transverse or perpendicular to the side of the banner 20. Connectors can be affixed to the tabs 850 and fix the banner to the legs of the golf banner. As shown, there are tabs 850 positioned closely adjacent each corner of the banner 20. It will be understood that additional tabs may be provided to affix the banner 20 to the legs 20 of a golf bag. The tabs can also be positioned on the banners described in any of FIGS. 1-7, 19A-19C, 24, 29, 30A-30F, 31A-31F, 32-40, and 41C.

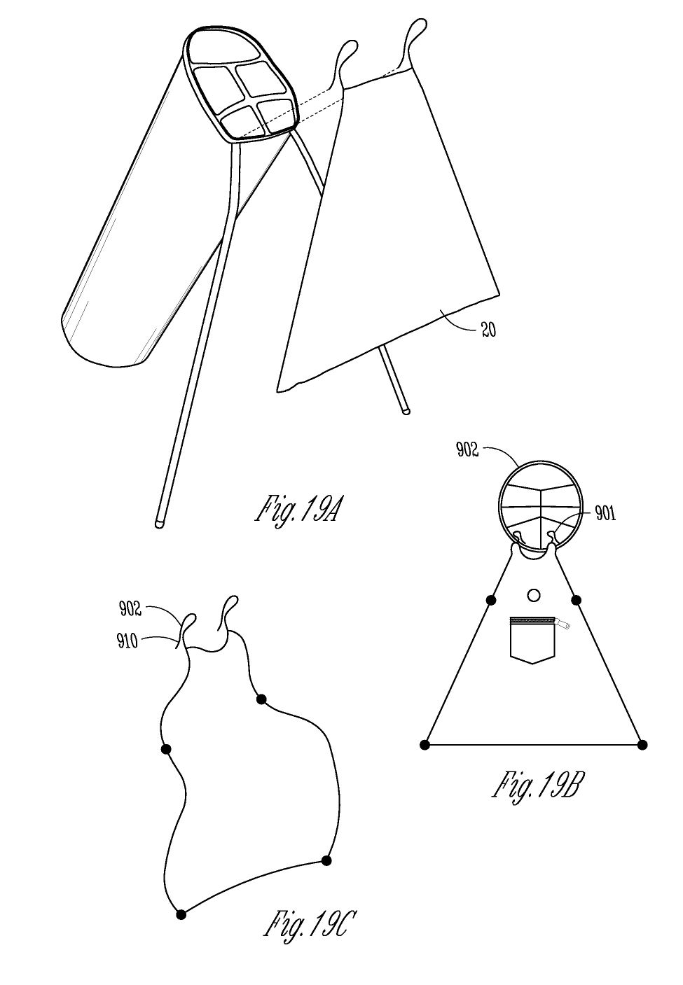

FIG. 19A shows a side view of an example of a golf bag 10 with a banner 20 affixed thereto. FIG. 19B shows an elevational view the banner 20. FIG. 19C shows the banner 20 free from the golf bag. The banner 20 is similar to the banner shown in FIGS. 18A and 18B but with a different top connector. The top connector includes a clamp assembly 901. The clamp assembly 901 can include at least one clamp, and as shown a plurality of clips, 902. The clips 902 include a part that is fixed adjacent the top of the banner 20 and a part 910 that cantilevers out from the banner and folds back on itself. The cantilevered part 910 extends into the interior space of the golf bag around its top lip to fix the top of the banner to the golf bag. In an example, the clip 902 includes a protective coating so that it will not damage or mar golf clubs in the bag. The clip 902 is made of a spring material and dimensioned so that it opens to allow the clip 902 to pass over the top edge of the top opening in the bag 10 and so that when in position, the clip 902 applies a spring force to the top edge of the bag 10 between the cantilevered part 910 and the base. The use of a plurality of clips 902 holds each side of the banner in place vertically along the length of the bag and does not allow one side to droop when the stand mechanism is in either the extended or retracted positions. Thus, the clips can be part of the fixture and prevent the sides of the banner from sliding downwardly on the legs.

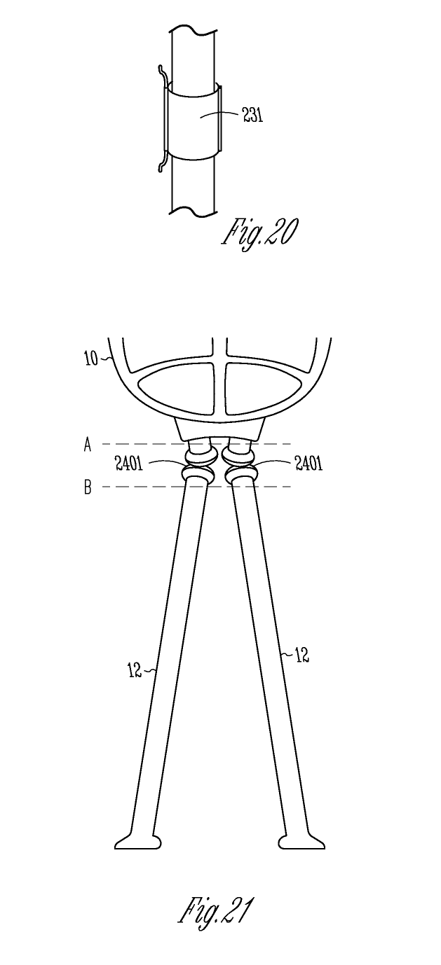

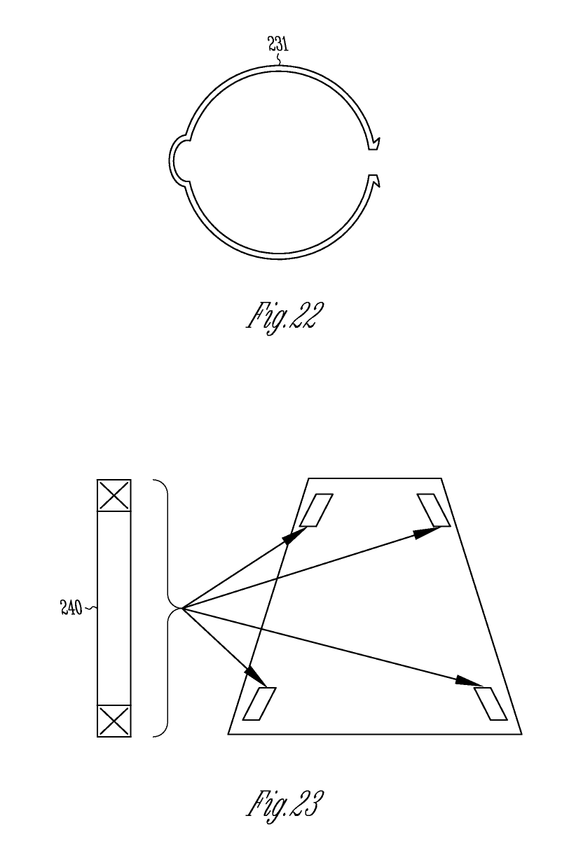

FIG. 20 shows a clamp 231 that can fix the banner to a leg 12 of a golf bag 10. FIG. 22 shows a top plan view of the clamp 231. The clamp 231 can be c-shaped clamp that is includes an opening through which the leg is forced. The arms of the clamp are forced apart until the leg is received in the volume of the clamp. The c-shaped clamp 231 fits around the leg 12. The c-shaped clamp 231 is made of a spring material that yields as the clamp 231 is placed around the leg 12 and then springs back to a position close to the relaxed position once in place around the leg 12. FIG. 22 shows a plan view of the clamp 231. A fixture can be placed on the interior of the clamp to fix the clamp at a vertical position in the golf bag leg.

FIG. 21 shows a stand mechanism with legs 12. The legs 12 can include a knuckle 2401 at the upper portion of the leg that allows the legs to pivot or fold between a retracted position adjacent the golf bag 10 and the stand position away from the golf bag 10. In an example, the banner 20 when attached to the bag 10, e.g., stand mechanism or legs 12, the banner 20 will connect above the knuckle 2401. The banner extending above the knuckle (e.g., at line A) provides a maximum area for the banner. The banner can also be connected at a position below the knuckle 2401 (e.g., at line B). The fixtures hold the banner away from the knuckle locations or vertically in position so that the banner does not interfere with the pivoting at the knuckles.

The banner 20 is positioned outwardly from the golf bag 10. For example, the banner defines a space or volume between it and the golf bag. In one example, the banner is essentially in the area defies between the legs of a bag stand. The banner covers the area in front of the bag such that the entire front face of the bag cannot be seen between the leg 12 with the banner in place. Other posts can extend outwardly of the bag to support the banner 20. In an example, the other posts can be linkages or other components of the stand mechanism. In a further example, the post is a banner support post or leg that includes at least a portion thereof that extends away from the golf bag.

The banner 20 as described herein can function to provide visual logos or other insignia that can identify the golfer or individualize a golfer's bag and look on the golf course. The banner 20 can serve as an advertising space for various vendors or to display team names. The banner 20 extends outwardly from the golf bag. In the example, the banner can resemble a sports uniform, team colors, team logo, number, name, etc. The banner 20 can operate as the sports uniform identifying a golfer on a team, e.g., high school golf team, college golf team, Ryder Cup team, Solheim Cup team, etc. An individual can also be identified. In an example, a celebrity on the golf course or a tournament golfer can have their name and a sponsor's logo on the banner.

In a further example, the banner 20 extends between the stand legs 12 and a portion of the banner extends back to the bag. The banner 20 can create a tee pee like structure with at least three panels. One panel covering a side from the bag to one of the stand legs. A second panel extending between the legs. A third panel extending from the legs back to the bag. The first panel and the second panel can cover essentially the entire respective area between the bag and the respective stand legs. The second panel can cover essentially the entire area between the legs. Fixtures operate to hold the banner in its vertical position on the leg and on the golf bag, when attached to the bag. The fixtures can be bands, elastics, straps, snaps, or other fasteners that will hold the banner 20 in its vertical position in both the extended and retracted positions.

A golf bag display device includes a banner made of material, and at least a portion of a coupling mechanism positioned to attach at least a first edge and a second edge of the banner. The banner is dimensioned to cover at least a portion of one plane in a space between a golf bag and a first leg and a second leg of a golf bag. In another embodiment, the banner is dimensioned to substantially cover at least one plane in a space between a golf bag and a first leg and a second leg of a golf bag. In one embodiment, the banner fits between the first leg and the second leg of the golf bag. In another embodiment, the banner fits between one of the first leg or the second leg of the golf bag, and the golf bag. For example, the banner covers a plane that includes one of the first and second legs and a point near or on the surface of the golf bag. The at least one portion of the coupling mechanism includes at least one opening positioned near one of the first edge or the second edge of the banner. The at least one portion of the coupling mechanism can also include a connector adapted for attachment to one of a first leg or a second leg of the golf bag. The at least one portion of the coupling mechanism can be a strap or collar attached to the banner. The strap is dimensioned to fit around the perimeter of the golf bag.

In another embodiment, the golf bag display device can include a fixture to hold the banner in a vertical position. In an example, the fixture can include a strap dimensioned to fit around the perimeter of the golf bag. The strap can also be provided with pockets and hook and loop fasteners to attach the ends of the strap to one another or to attach accessories thereto. The pockets can be sized to fit a portion of a coupling mechanism, such the end of a rod, dowel or the like. The fixture for the golf bag display device can include a hem of material near the perimeter of the banner. The hem forms an elongated sleeve that can carry or house a dowel. In a further example, the hem can include a cord. The cord can be elastic and can have ends that fit within a pocket. One strap can be placed around the perimeter of the bag near the top and another strap can be placed around the perimeter of the bag near the bottom. The top and bottom of a golf bag generally are more substantial or reinforced than the rest of the length of the bag. A dowel or elastic cord can be placed in a hem of the display and the ends of the dowel or elastic cord can be attached to the straps, or to pockets provided in the straps. The golf bag display device can also include at least one accessory attached to the banner. In some embodiments, a plurality of accessories may be attached to the banner. In still other embodiments, the banner includes at least one pocket therein. The pocket can be large or small. For example a larger pocket can be provided as a target for receiving chipped or pitched golf balls. Other pockets can be provided to hold writing instruments, score cards, or other desired accessories. The pocket can also hold a club cover. In one embodiment, a large pocket can also serve as a club cover. The banner material can be of any type of material including waterproof materials or water resistant materials. In some embodiments, some of the banners may be made of mesh. The mesh material, in one embodiment, would have openings sized to allow wind to pass through the banner so as to still allow a display area but to prevent wind loads that might topple the bag when in the standing position.

The fixture structures described herein holds the banner 20 in position and keeps the banner from interfering with operation of the stand mechanism, e.g., the knuckle 2401.

FIG. 23 shows a bridge 240 through which a clamp or connector can extend and then connect to the leg. The bridge 240 is elongate and fixed at its end to the banner to create an opening through which the connector or clamp extends. A number of bridges can be used to provide a number of clamping spots or attachment points for the banner. The bridge(s) 240 generally are affixed to the banner 20 at each location where a connector is used. Of course, some bridges 240 need not be used in a particular application.

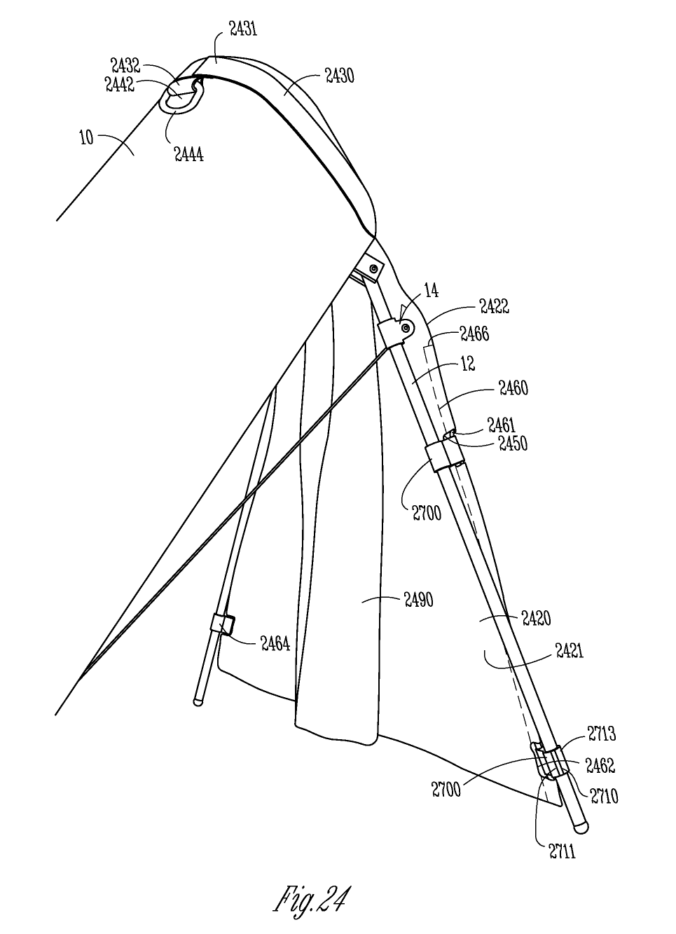

FIG. 24 shows a perspective view of banner 2420 attached to the legs 12 of a stand mechanism 14 of a golf bag, according to yet another example embodiment. FIG. 26 shows a perspective view of the banner 2420 as attached to the top of the golf bag 10. The banner 2420 is accessorized with a golf towel 2490. As shown in FIG. 25, the banner 2420 is made of a waterproof or water resistant fabric. The banner 2420 includes a first portion of a hook and loop fastener attached to the surface 2421 of the banner 2420 closest to the bag 10. The golf towel 2490 includes the second portion of hook and loop fastener. The golf towel 2490 can then be removably attached to the surface 2421 for any purpose, including protecting the towel from inclement weather or merely to hide the towel 2490. The other surface 2422 of the banner 2420, in some embodiments, is also provided with a strip of the first portion of hook and loop fastener so that the towel 2490 can be attached to the outer surface 2422 of he banner 2420. Attached to a top edge 2424 of the banner 2420 is a collar 2430. The collar 2430, as shown in FIG. 24, includes a first end 2431 and a second end portion 2432. The first end 2431 of the collar 2430 includes a first portion of hook and loop fastener 2441 and the second end 2432 of the collar 2430 includes a second portion of hook and loop fastener 2442. The collar 2430 can then be attached to any bag with a range of peripheral distances associated with the top of the bag. Attached to the exterior surface of the collar 2430 is another first portion of hook and loop fastener dimensioned so that the golf towel 2490 can be removably attached thereto, as shown in FIG. 25. In some embodiments, the collar 2430 is provided with yet another portion of hook and loop fastener positioned another exterior position so that the golfer can choose where to attach the golf towel 2490. For example, a golfer could choose between a right side position and a left side position on the collar 2430 near the top of the golf bag 10 or a position on surface 2421 or surface 2422 on the banner 2420. The collar 2430 can be part of the fixture structure to hold the banner in an elongated vertical position when on the stand mechanism.

The banner 2420 also can include a rod or dowel 2450 along a first edge 2424 and along a second edge 2426 of the banner. A rod 2450 is shown in FIG. 25. The first edge 2424 of the banner includes an elongated pocket 2460 sized to receive the rod or dowel 2450. The elongated pocket 2460 includes at least one connector opening 2462 therein. As shown in FIG. 25 there are two connector openings 2462 and 2461 in the elongated pocket. Portions of the rod 2450, are exposed at the connector openings 2461. 2462 when the rod is placed in the elongated pocket 2460 near the first edge 2424 of the banner 2420. It should be noted that the second edge 2426 of the banner 2420 also includes another elongated pocket with connector openings therein. A second rod (not shown) is placed in the second elongated pocket at the second edge 2426. The banner 2420 is connected to the legs 12 of the stand device 14 of the golf bag 10 using a connecter 2700, which is detailed in the following paragraph.

FIG. 27 is a top view of the connecter 2700, according to an example embodiment. The connector 2700 includes a rod connection portion 2750 and a leg connection portion 2712. In the embodiment shown, the rod connection portion 2750 has a diameter that is less than the leg connection portion 2712. The inner diameter of the rod connection portion 2750 is approximately equal to the outer diameter of the rod 2450 (shown in FIG. 25). The inner diameter of the leg connection portion 2712 is approximately equal to the outer diameter of the leg 12 (shown in FIG. 25). The connector 2700 also includes an opening 2710 in the periphery of the connector 2700. The opening 2710 can be described as a slit or slot. The connector includes a first out turned edge 2711 along one edge of the opening 2710 and a second out turned edge 2713 along one edge of the opening 2710. The connector 2700 is sized so that it holds both the rod 2450 and the leg 12 when connecting the banner 2400 to the bag stand mechanism 14. The connector 2700 can be made of any material capable of deforming in an elastic range when using the connector 2700. For example, the connector 2700 can be made of spring steel material or a polymer material. When made of spring steel, the connector 2700 is coated with a plastic material so that it minimizes the possibility of scratching other surfaces, such as the surface of the legs 12. The plastic coating may be applied by dipping the connector 2700 into a plastic dip. The dipped connector 2700 may also be more pleasing in appearance.

In operation, connecting the banner 2400 to the legs 12 includes placing the rods 2450 into the first elongated pocket 2460 and into the second elongated pocket 2464. Only one rod placement will be detailed here for the sake of brevity. The rod 2450 is inserted into the pocket 2460 until it hits a reinforced stitching 2466. In this position, portions of the rod 2460 are exposed at the connection opening 2461 and 2462. Connectors 2700 are then placed onto the rod 2450. The rod 2450 passes through the opening 2710, through the leg connection portion 2712 and into the rod connection portion 2750. The connector 2700 may yield elastically when passed though the opening 2710 and through a transition area 2730 between the rod connection portion 2750 and the leg connection portion 2712. The connector 2700 is then attached to the rod 2450 at a connection opening, such as connection opening 2461 in the pocket 4260 of the banner 2420. The leg 12 is then passed through the opening 2410. The tabs or outturned edges 2711, 2713 prevent the edges of the opening 2710 from digging into the material of the leg 12. It should be noted that the rod or dowel 2450 is removable from the pocket 2460 so that the banner 2420 can be easily made flat during operations that include printing or placing a display on the banner 2420. The rod 2450 is also removable for easy replacement of the rod 2450. It should be noted that another rod is placed into pocket along the edge of the banner 2420 near the other leg 12. The other rod is similarly attached to the other leg 12 using connector 2700.

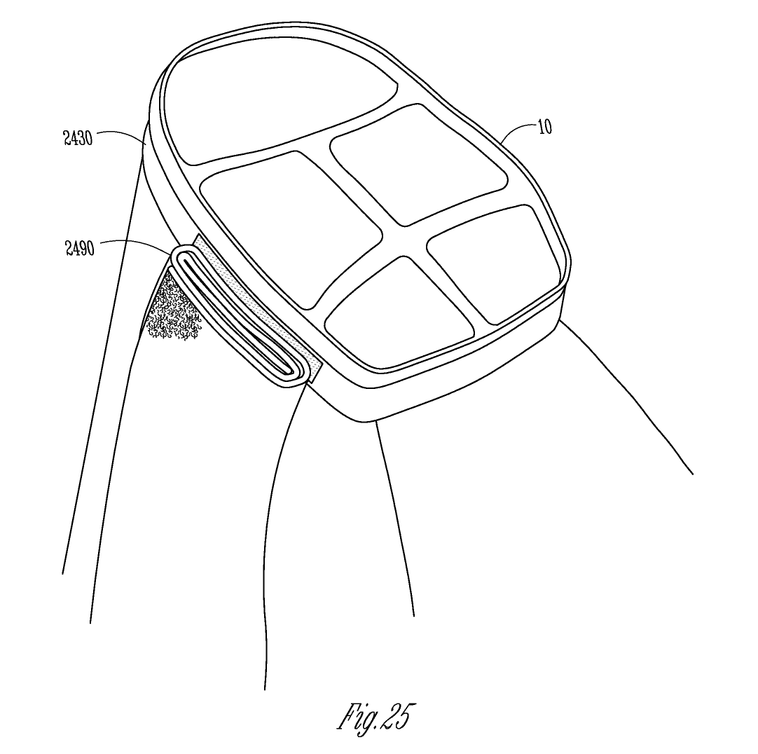

FIG. 28 shows a cross sectional view of a banner 2820 attached to a leg 2812, according to another example embodiment. FIG. 29 shows a side view of a leg 2812 having a slot 2810 therein, according to another example embodiment. The banner 2820 includes an elongated pocket 2860 made by, for example, hemming an edge of the banner 2820. The elongated pocket 2860 receives a rod 2450. The leg 2812 includes an elongated slot 2810. The rod 2450 within the pocket 2860 has a dimension which is larger than the width of the elongated slot 2810. The rod 2450 and the pocket are placed in the bottom of the leg 2812 and moved up the leg 2812 until the bottom of the banner 2820 is within the slot 2810. An endcap 2910 is then placed on the end of the leg 2812 to provide a stop for the banner 2820 and to keep the bottom of the leg from deforming and making the slot 2810 wider. The end cap 2910 also provides strength to the leg 2812.

The above described rods, hems and connectors can be part of the fixture assembly and can assist in preventing the banner from moving up and down the legs of the golf bag.

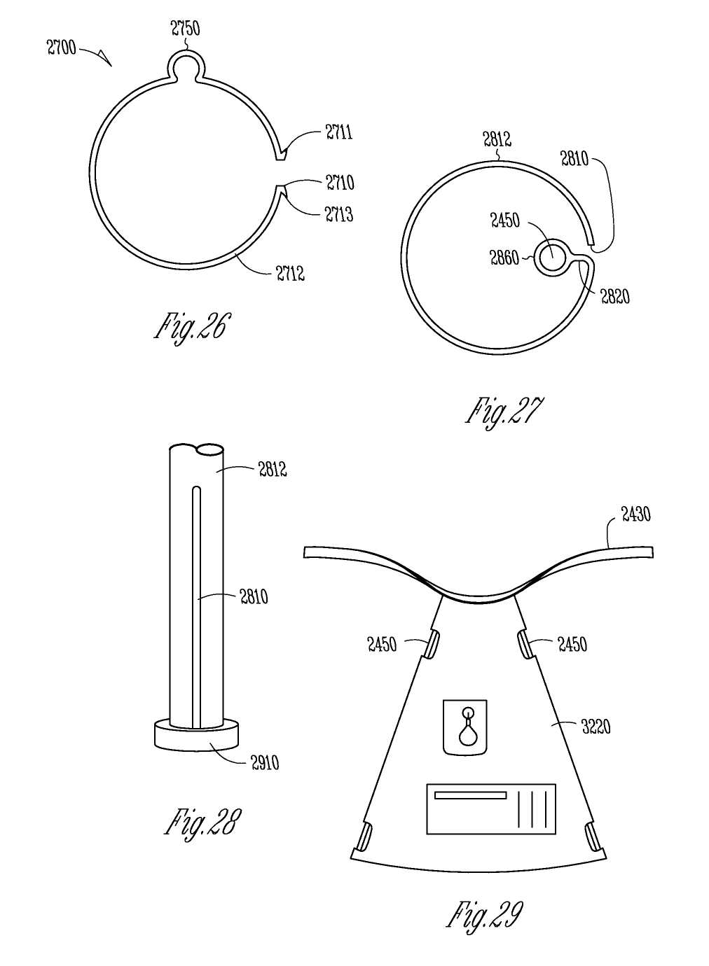

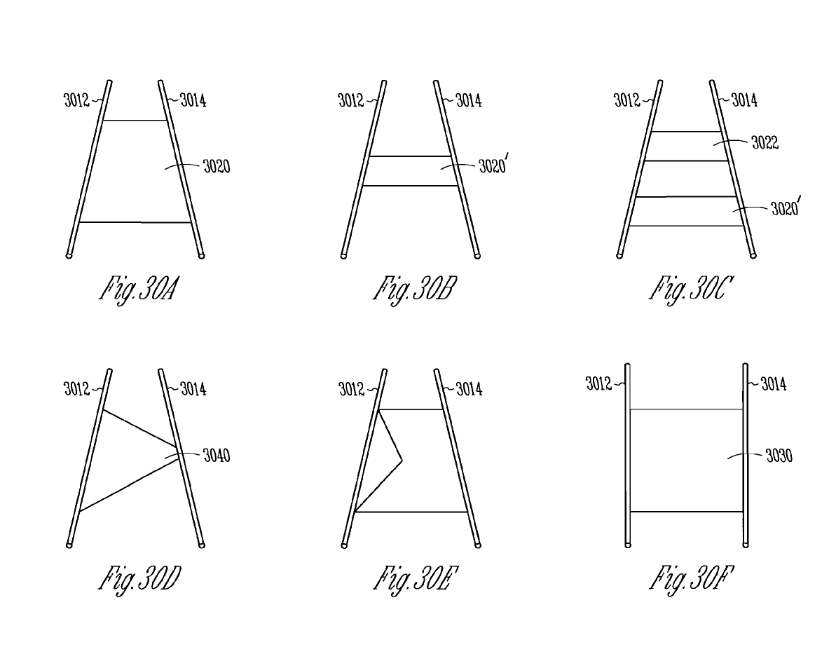

FIGS. 30A, 30B, 30C, 30D, 30 E and 30F, show various partial views of banners positioned between a first leg and a second leg of a golf bag (not shown), according to example embodiments. The FIGS. 30A-30E show that banners of most any shape and size is contemplated. It should be noted that FIGS. 30A-30E is not an exhaustive showing of the various banners contemplated but merely a representative sampling. The banners need not take up the entire space between the legs 3012, 3014 as can be seen by all the various banners shown in FIGS. 30A-30E. Specifically, FIG. 30A shows one embodiment where a banner 3020 attached between legs 3012 and 3014 has a height which is about 75 percent the height of the legs 3012, 3014. The height of the banner 3020 can be any desired height. As shown in FIG. 30B, the banner 3020′ attached between legs 3012 and 3014 has a height which is less than half the length of the legs 3012, 3014. FIG. 30C shows a banner arrangement where there are more than one banner 3020′ and 3022 attached to the legs 3012, 3014. Other banners need not be trapezoidally shaped. For example, as shown in FIG. 30D, a banner 3040 is triangularly shaped. Other banners can include cutouts such as the banner shown in FIG. 30E which includes a triangular cutout near one edge. Certain flags have a similar shape, such as marine flags and flags associated with particular countries. It should also be noted that the banner need not be trapezoidally shaped. Some bags may have bag stand mechanisms where the legs 3012, 3014 deploy to a position where the legs are roughly parallel to one another. In this case, a banner 3030 will be rectangular in shape. Of course, many variations in the shape of the banner 3030 can be made with respect to a rectangular space between the legs.

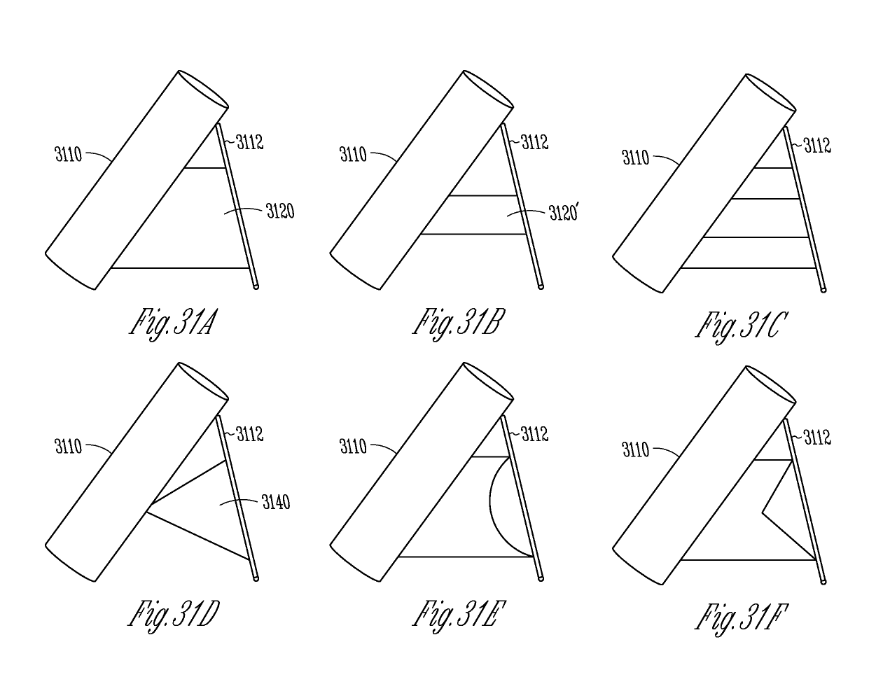

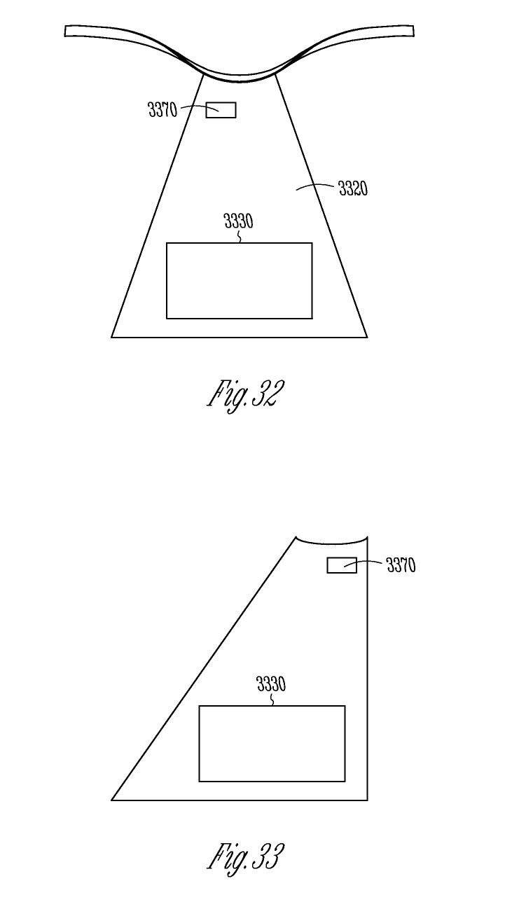

FIGS. 31A, 31B, 31C, 31D, 31E and 31F, show various partial views of banners positioned between one leg of a golf bag stand (not shown), and a golf bag 3110, according to example embodiments. The FIGS. 31A-31E show that banners of most any shape and size is contemplated. It should be noted that FIGS. 31A-31F is not an exhaustive showing of the various banners contemplated but merely a representative sampling. The banners need not take up the entire space between the leg 3112 and the golf bag 3110 as can be seen by all the various banners shown in FIGS. 31A-31F. Specifically, FIG. 31A shows one embodiment where a banner 3120 attached between leg 3112 and bag 3110 has a height which is about 75 percent the height of the leg 3112 and covers much of the space between the leg 3112 and the bag 3110. The height of the banner 3120 can be any desired height. As shown in FIG. 31B, the banner 3120′ attached between legs 3112 and bag 3110 has a height which is less than half the length of the leg 3112. Such a banner 3120′ can be placed at any desired height along the length of the leg. The banner 3120′ also need not be substantially parallel to the ground when the bag 3110 is in its standing position. FIG. 31C shows a banner arrangement where there are more than one banner 3120′ and 3122 attached to the leg 3112 and the bag 3110. Other banners can have other shapes. For example, as shown in FIG. 31D, a banner 3140 is triangularly shaped. Other banners can include cutouts such as the banner shown in FIG. 31E which includes a triangular cutout near one edge. FIG. 31F features a semicircular cutout. Many shapes are contemplated and can even be mixed and matched to form various patterns around the bag 3110. It should be noted that one side of the bag 3110 is shown in FIGS. 31A-31E and that the other side can also include a banner. In some embodiments the banners are symmetrical on each side while in other applications the treatments on each side of the bag 3110 can be asymmetrical.

FIG. 29 shows an embodiment of the banner 3220 in which a pocket 3230 is provided which is removable, according to an example embodiment. The removable pocket 3230 can be removed so that a substantially flat surface can be presented at various times, such as when printing on the banner. The banner 3220 also includes a removable pocket 3242 on the backside of the banner 3220. The pocket 3242 is shown with hidden lines. Such a pocket can hold any desired item, such as a retraction mechanism 3230. The retraction mechanism 3230 includes a line 3232 with a connector 3234 attached to the end of the line 3232. The connector 3234 can be used to attach any desired item, such as a brush or cleat cleaning tool. The line 3232 and the connector 3234 may also be called a lanyard. In some embodiments, the lanyard can be nonremovable and be provided with a brush or other tool. If placed in a removable pocket, the connector 3234 can be removed and then the line can be passed through the opening in the banner 3220 so that it could be easily replaced or removed to print onto the banner 3220. Pockets or pouches can be placed on the front or back of the banner 3220.

Any pocket or pouch discussed above, including those that are fixed to a banner or removably attached to a banner can be made of various materials. One material contemplated is a PVC laminated, brushed tricot material. The material is soft to the touch and extremely water resistant.

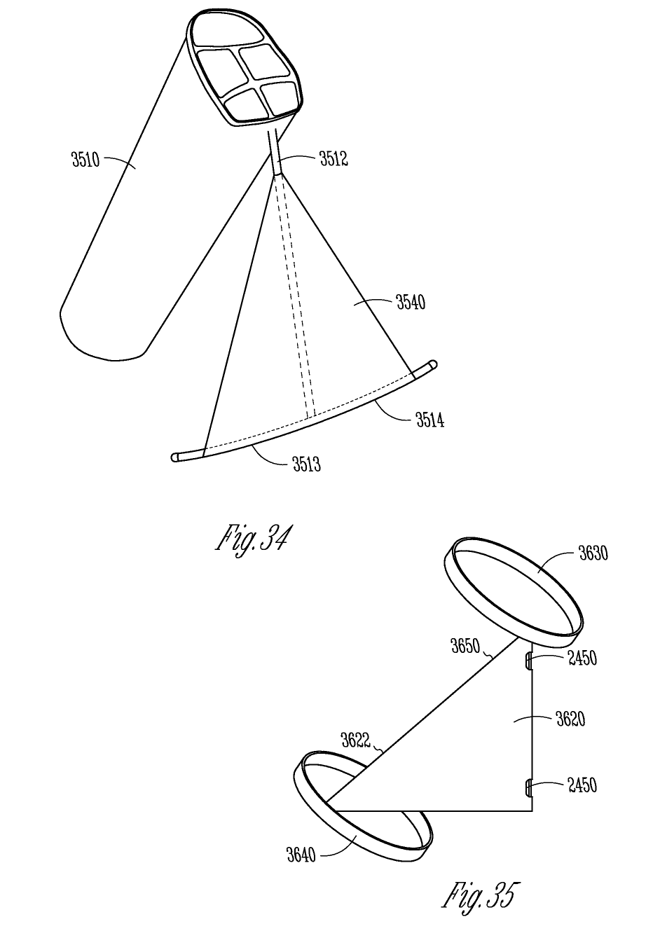

FIG. 33 shows an embodiment of a banner 3320 in which a solar panel 3330 is provided, according to an example embodiment. FIG. 34 shows an embodiment of a bag side banner 3420 in which a solar panel 3330 is provided, according to an example embodiment. In one embodiment, the front of the banner includes a solar panel. The solar panel can be removably attached to the banner 3320 or can be permanently attached to the banner 3320. The solar panel 3330 can be of a shape or size. The solar panel 3330 can be attached to a banner 3320 between the legs or to a banner 3420 adapted to be attached between a leg and a side of the golf bag (not shown. The solar panel 3330 can be used to power various electrical devices including radios, gaming systems, stereos, cell phones, locating devices, such as a global positioning system or the like. In some embodiments, the solar panel can be sewn to the banner. In other embodiments, a pocket with stiff edges can hold the solar panel in place. In still other embodiments, the pocket can be provided with a clear window to allow light to pass therethrough. The solar panel 3330 can be used to charge devices, such as cell phones, for later use. The solar panel could also be used to power electronic devices or lights that can be provided on board the golf bag or on the banner.

Any banner can be provided with other elements, such as electronics. Various pouches and bags can be provided to store the electronics. In some embodiments, the bags or pouches are removable so that, when printing, the banner can be laid flat. As mentioned previously, the pockets and pouches may hold a location device, such as a position navigation system or a Global Positioning System (GPS). Other types of navigational positioning systems are contemplated. Other systems can include Beidou, COMPASS, Galileo, GLONASS, Indian Regional Navigational Satellite System (IRNSS), or QZSS. Moreover, these systems can use Real Time Kinematic (RTK) satellite navigation to provide the real-time corrections of the positioning signal down to a meter or centimeter level of accuracy. The systems can also use differential correction signals in North American from the FAA's WAAS satellites. Accordingly, references herein solely to GPS should be read to as general position navigation systems.

One use for such a location device, such as a position navigation system, is an distance to pin estimator. The location of the bag 10 could be automatically monitored. The global coordinates for each pin could be provided to a computer or even mobile device or a mobile phone running a software application. The scores could be input electronically at the previous hole and the device could, as a default, bring up the pin placement for the next hole. A computer could determine the location of the pin, and the bag and display the distance between the two. The banner could even be provided with a display 3370 that shows the golfer the distance to the pin. The display could also include an input device for selecting a particular hole being currently played to override the default setting for the hole. In some embodiments, the hole number could be automatically selected when the bag is placed within a certain distance of a known tee box for a hole. This could be used for club selection and for determining how to play the selected club.

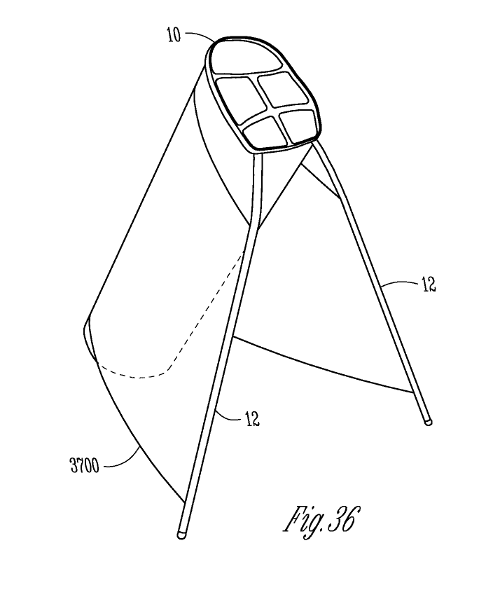

FIG. 35 shows an embodiment of a mechanical stand having only one leg and a banner 3520 therefore, according to an example embodiment. Other stand mechanisms could also be provided with banners. As shown in FIG. 35, a bag 3510 is provided with a single leg stand mechanism 3540. One or two banners can be attached to the single leg and to the bag or a position near the bag 3510. A triangular banner 3520 could also be attached to the leg 3512 and the cross legs 3513, 3514. A banner can be fashioned for any variation in the bag stand device 3540 associated with the bag 3510.

FIG. 36 shows a system for connecting a side banner 3620 to a bag 3610. The system would include a top collar 3630 and a bottom collar 3640. The top collar 3630 would be dimensioned to fit around the top of the bag 3610. The bottom collar 3640 would be dimensioned to fit around the bottom of the bag 3610. The top collar 3630 and the bottom collar 3640 could be made from an elastic material or could have a first end and a second end with the various parts of a hook and loop fastener so that the collars could be adjustably attached to the top and bottom of the bag 3610. The top collar 3630 could be provided with a narrow pocket 3632 for receiving one end of a rod 3650 and the bottom collar 3640 could also include a narrow pocket 3642 for receiving the other end of the rod. The banner could be provided with a hem that forms an elongated narrow pocket 3622 for holding the rod 3650 along the edge closest the bag 3610. As shown, there is one pocket 3632 shown in top collar 3630 and there is one pocket 3642 in bottom collar 3640. In other embodiments, pockets can be provided so that a side banner, such as side banner 3620 can be held on the left side or the right side of the bag 3610. In still another embodiment, a plurality of narrow openings is provided on each side of the bottom collar 3640 and on each side of the top collar 3630. This would provide several openings for receiving the rod ends. Attachment could then be easily adjusted by moving the rod end over several openings to improve the fit. The collars could also be made in neutral colors that would blend with many bags or could be made in multiple colors to compliment the color of a bag or to match it.

The collars could also hold other items such as cup holders. The clip 2700 could also be adapted to hold a cup or cup holder to the leg of a golf bag. A cup holder could be provided with a rod or dowel of a similar diameter as the rods used to hold the banners. The cup holder would hold the liquid container in a position substantially aligned with the force of gravity such that the liquid will not spill from the container. In an example, the cup holder portion is tiltable relative to the leg of the stand mechanism.

FIG. 36 shows an embodiment of a shawl 3700 for covering a bag 10, according to an example embodiment. Other embodiments might include a bag cover 3700 that would wrap around the entire bag. This could be likened to a shawl that wraps entirely around the bag 10. The shawl 3700 would have openings therein to allow for access to pockets and pouches on the bag itself. Other pockets and pouches could be provided on the shawl. Advertisements or other displays could be placed anywhere desired on the surface of the shawl. The shawl could also be provided with a hood (not shown) that could be deployed to cover the club heads. The hood could be provided in a pocket at or near the top edge of the shawl. In other embodiments, it could merely be attached to the top of the shawl 3700 so it could be quickly deployed at will.

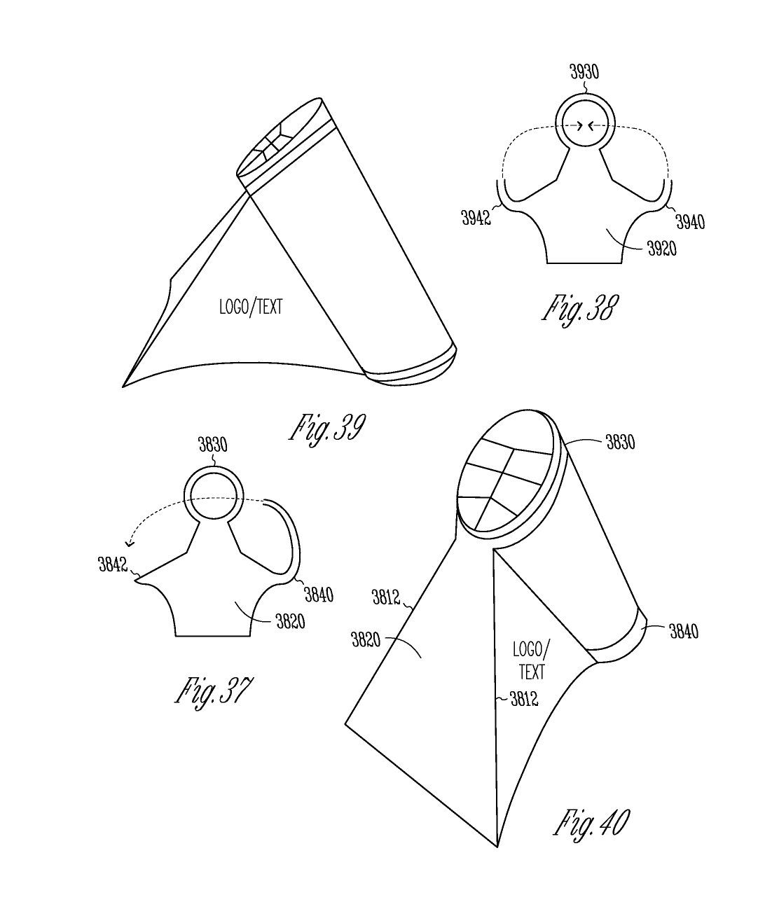

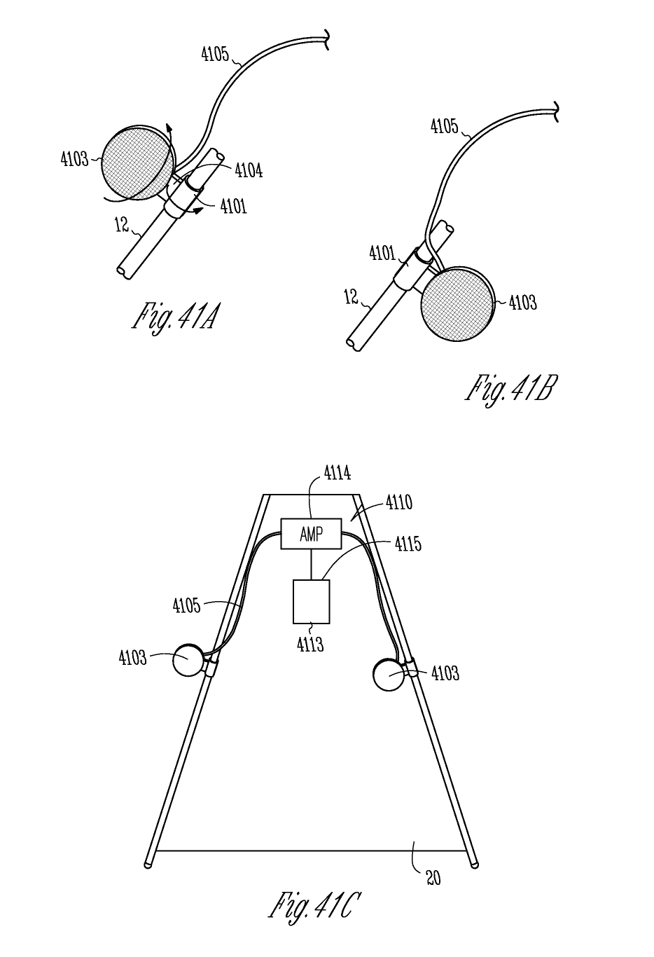

FIG. 37 shows a top view of a three sided display device 3820 according to an example embodiment. FIG. 38 shows a top view of another three sided display device 3920, according to an example embodiment. FIGS. 37 and 38 will now be discussed in connection with FIGS. 39 and 40, each of which show the three-sided display device. FIG. 39 shows a side view of three-sided banner attached to the legs of a stand mechanism, according to an example embodiment. FIG. 40 shows a perspective view of three-sided banner attached to the legs of a stand mechanism.

The two three sided display devices 3820 and 3920 are closely related. The three sided display device 3820 includes a 3830 and a portion of fabric attached to the collar that forms and covers three sides, namely an area between the right side of the bag 3810 and one of the legs 3812, an area between the legs 3812, and an area between the left side of the bag 3810 and the other of the legs 3812. Attached to the fabric is a connector arm 3840 and a connector arm 3842. The collar arm 3840 will carry a first portion of hook and loop fastener while the collar arm 3842 will carry a second portion of hook and loop fastener. The collar arm 3840 can then be wrapped around a bottom portion of the bag 3810 to removably attach the banner 3820 to the bag.

The display device 3920 is very similar to the display device 3820. The three sided display device 3920 includes a 3030 and a portion of fabric attached to the collar that forms and covers three sides, namely an area between the right side of the bag 3810 and one of the legs 3812, an area between the legs 3812, and an area between the left side of the bag 3810 and the other of the legs 3812. Attached to the fabric is a connector arm 3940 and a connector arm 3942. The collar arm 3940 will carry a first portion of hook and loop fastener while the collar arm 3942 will carry a second portion of hook and loop fastener. The collar arms 3940 and 3942 are substantially equal in length. As a result, the collar arm 3940 can then be wrapped partially around a bottom portion of the bag 3810, and the collar arm 3942 is similarly wrapped around a portion of the bottom of the bag and attached to one another to removably attach the banner 3920 to the bag.

The banner described herein that extend to the golf bag container or attach at places other than the legs. The banner can be sewn or adhered directly to the golf bag container such that the banner is integral with the golf bag.

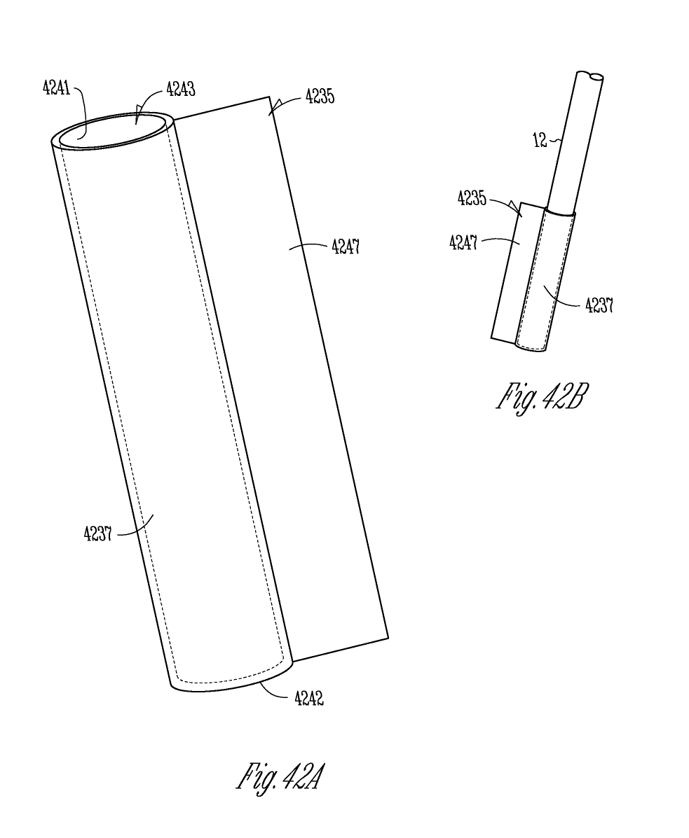

FIGS. 41A-41C show a speaker attachment 4100 for a golf bag leg 12. The speaker attachment can include a clip 4101 and a speaker 4103 held on the clip by a pivotable joint 4104. The speaker 4103 is a weather resistant speaker that can be used outdoors. The pivotable joint allows the speaker to pivot to face a direction desired by the user and to hold the speaker in a position where it will not interfere with operation of the stand mechanism of the golf bag. A wire 4105 runs from the speaker along the leg 12 of the golf bag to connect to audio sources. See FIG. 41C. The clip holds the speaker in a position outward of the leg 12. The clip 4101 can be removable from the leg 12. In an example, the clip 4101 can be a connector for the golf bag banner. In a further example, the clip 4101 is connected to a stiffener rod or the fixture structure (rod, hem, etc.). The wire 4105 runs from the speaker along the stiffener rod or the fixture structure of the banner to connect to audio sources. FIG. 41B shows the speaker 4103 being positioned inwardly of the golf bag leg. FIG. 41C shows an assembly 4110 of an audio system with multiple speakers 4103 on pivoting joints 4104 connected to clips 4101. The assembly 4110 is shown in FIG. 41C on the back or under side of a banner 20. Here, the wires 4105 can be affixed to the banner 20. One speaker is shown outwardly of the banner 20 and the other is shown inwardly or beneath the banner 20. An amplifier 4114 is provided to increase the volume and the sound quality. A pocket 4113, which can be waterproof, is provided to store the electronics 4115 that produce the audio signal. Electronics 4115 can include portable music players or mobile phones.

FIGS. 42A and 42B show a further fixture 4235 that includes a sock 4237 that can slide on the bottom of a golf bag leg 12. The sock 4237 has an open top 4241 and a closed bottom 4242 with a receptacle 4243 for receiving the lower end of the golf bag leg. The closed bottom end of the sock will contact the foot of the leg 12 and prevent the sock from sliding upwardly on the leg 12. The sock 4237 can be integrated into the banner. In an example, the sock 4327 can be a separate piece and includes a flag 4247 extending outwardly from the main body of the sock. The flag 4247 provides an attachment to which the banner can be affixed. The flag 4247 can have one part of a hook and loop fastener and the banner can have the other part of a hook and loop fastener.

In a further example, the fasteners to keep the banner elongate along the length of a leg of the golf bag can include pop rivets or other suitable fasteners to the leg of the golf bag. Other types of fasteners can be a snap with one of the male or female parts of the snap on the leg or golf bag and the other on the banner 20 or attached to the banner through an intermediate structure, e.g., a tab, an elastic edge, an elastic band, extension, etc.

The fixture can also include other structure to hold the banner in place on the legs. In an example, the banner includes pockets at the bottom of the banner into which the legs can be inserted. The pockets can be closed at the bottom so that the banner cannot slide upwardly on the legs.

The fixture can also be a hook and loop fastener that extends substantially the length of the sides of the banner. The structures of hook and loop fasteners are typically rigid enough to prevent a banner from sliding up or down, or bunching, along the length of golf bag legs. In a further example, one part of the hook and loop fastener is fixed at a location on the golf bag leg. The other part can be fixed to the banner. The two parts can be removably connected. The first part being fixed at a location on the leg, e.g., permanently, or non-moveably along the length of the leg, provides the fixture necessary to improve the operation of the banner so as to reduce the chance of interfering with operation of the stand mechanism.

It will be appreciated by those of in the art that the presently described embodiments can be used with golf bag legs of any shape and can be adapted for any length of leg. While most legs for golf bag stand mechanisms are cylindrical, other shapes, such as polygonal cross sectioned legs can be used with the present disclosure.

The banner as described herein can also be formed to be part of a gold bag leg. In an example, the banner is rolled within a leg with a portion of the banner extending outwardly of a slit. The banner can be structured similar to a blind. A stop can be attached to the free end of the banner to keep the banner from retracting completely within the leg. The user grips the stop or free end of the banner and pulls the banner to the attachment on either the other golf bag leg or the golf bag. The banner is fixed to the attachment, for example, in manners described herein. Accordingly, the banner can be easily displayed and retracted when not in use.

The banner as described herein can be used on golf bags with legs of various lengths and not rely on exact fitting to the legs. If a banner must be attached at the top of the golf bag's container, then the bottom of the banner may be to high and prevent the legs from fully extending. The present banner can be used on any length legs and adjusted to any height and then affixed to the legs at an appropriate height to allow the stand mechanism to work properly. The rigid or semi-rigid sides, provided by a thickened hem, rods, dowels, or extra layers, keep the banner elongate with the legs so as to not entangle with the stand mechanism. Other embodiments provide this feature with fixing the corners of the banner or adjacent the corners to keep the banner elongate along the legs without bunching, riding up the legs or sliding down the legs as the legs move between positions.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The use of the term “or” in the present description should be interpreted as an non-exclusive or unless otherwise stated.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

It is emphasized that, for purposes of the United States, the Abstract is provided to comply with 36 C.F.R. §1.62(b) requiring an Abstract that will allow the reader to quickly ascertain the nature and gist of the technical disclosure. It is submitted with the understanding that it will not be used to interpret or limit the scope or meaning of the claims.

We claim:

1. A golf bag banner, comprising:
a flexible body movable between at least a first position and a second position;
a connector mechanism to secure the flexible body to a leg of a golf bag; and
a fixture to keep the flexible body in a vertically fixed position along the leg of a golf bag.

2. The golf bag banner of claim 1, wherein the flexible body includes a lightweight fabric that can fold with the movable, golf bag leg between a retracted position and a bag stand position.

3. The golf bag banner of claim 1, wherein the flexible body includes a multi-layer fabric and an image on an outside of the multi-layer fabric.

4. The golf bag banner of claim 1, wherein the flexible body includes a main body and an elastic edging extending longitudinally adjacent the leg.

5. The golf bag banner of claim 1, wherein the flexible body includes at least one of a magnet, a pocket, a music playing device, a flexible elongate connector, or combinations thereof.

6. The golf bag banner of claim 1, wherein the connector mechanism includes at least one of straps sewn to the flexible body, button holes or slots in the flexible body, a length of material that can be tied around the moveable leg of the golf bag, a plastic clamp, parachute clips, straps, or combinations thereof.

7. The golf bag banner of claim 6, wherein the connector mechanism includes a non-slide surface that engages a leg of a golf bag.

8. The golf bag banner of claim 1, wherein the connector mechanism includes a clamp, and wherein the clamp includes a non-slide surface that engages a leg of a golf bag and does not slide up and down the leg of the golf bag.

9. The golf bag banner of claim 1, wherein the connector mechanism includes a tube formed from the outside edges of the flexible body.

10. The golf bag banner of claim 1, wherein the connector mechanism includes a tube that is attached to the flexible body that is suitable to receive a moveable leg of the golf bag.

11. The golf bag banner of claim 1, wherein the flexible body includes at least one of an elastic border, hook and loop fastener material along one or more borders of the flexible body, and one or more zippers along the border of the flexible body, or combinations thereof.

12. The golf bag banner of claim 1, wherein the flexible body is water resistant and includes a back surface and a front surface, wherein the flexible body is to hold a towel adjacent the back surface proximal to the golf bag such that the front surface would shield the towel from moisture with the flexible body being either compressed adjacent the golf bag or extended with legs of the golf bag.

13. A golf bag display device for use with a stand golf bag, comprising:
a banner including a first edge and a second edge;
a stiffener extending lengthwise adjacent one of the first edge and the second edge; and
at least a portion of a coupling mechanism positioned to attach at least a first edge and a second edge of the banner, the banner dimensioned to cover at least a portion of a plane in a space between a golf bag and a first leg and a second leg of a golf bag;
wherein the stiffener rod is to hold the banner in position along one of the first leg and the second leg so as to not interfere with operation of the first leg and the second leg of the golf bag.

14. The golf bag display device of claim 13 wherein the banner fits between the first leg and the second leg of the golf bag.

15. The golf bag display device of claim 13 wherein the banner fits between one of the first leg or the second leg of the golf bag, and the golf bag.

16. The golf bag display device of claim 13 wherein the at least one portion of the coupling mechanism includes at least one opening positioned near one of the first edge or the second edge of the banner.

17. The golf bag display device of claim 13 wherein the at least one portion of the coupling mechanism includes a connector adapted to attach to one of a first leg or a second leg of the golf bag.

18. The golf bag display device of claim 13 wherein the at least one portion of the coupling mechanism includes a strap attached to the banner, the strap dimensioned to fit around the perimeter of the golf bag.

19. The golf bag display device of claim 13 wherein the at least one portion of the coupling mechanism includes a hem of material near the perimeter of the banner.

20. The golf bag display device of claim 19 wherein the stiffener includes a dowel positioned within the hem.

21. The golf bag display device of claim 20 wherein the at least one portion of the coupling mechanism includes a cord positioned within the hem.

22. The golf bag display device of claim 22 wherein the banner includes a mesh material.

23. The golf bag display device of claim 13 further comprising at least one accessory attached to the banner.

24. The golf bag display device of claim 13 wherein the material includes at least one pocket therein.

25. The golf bag display device of claim 13 wherein the banner is dimensioned to substantially cover at least one plane in a space between a golf bag and a first leg and a second leg of a golf bag.

26. A golf bag, comprising:
a container to receive golf clubs therein;
a stand connected to the container, the stand including at least two legs moveable between a stand position and a retracted position;
a bag banner connected between the two legs, the bag banner including:
a flexible body movable between at least the stand position and the retracted position;
a positioning mechanism to hold the flexible body along the length of legs so as to not bunch an interfere with operation of the stand; and
a connector mechanism to secure the flexible body to the two legs.

27. The golf bag of claim 26, wherein the positioning mechanism includes a stiffening rod extending along an edge of the bag banner.

28. The golf bag of claim 26, wherein the flexible body includes an aperture adjacent the stiffening rod and wherein the connector mechanism extends through the aperture to engage the stiffener rod and one of the golf bag legs.

29. The golf bag of claim 26, wherein the connector mechanism engages the positioning mechanism to secure the bag banner to the two legs.

30. The golf bag of claim 26, wherein the flexible body includes a first edge and a second edge, wherein the positioning mechanism includes a first stiffening rod extending adjacent the first edge and a second stiffening rod extending adjacent the second edge, wherein the connector mechanism includes a first connector engaging the first stiffener rod and a first leg of the two legs and a second connector engaging the second stiffener rod and a second leg of the two legs.
